(19) United States
(12) Patent Application Publication
(10) Pub. No.: US 2021/0109312 A1
(43) Pub. Date: Apr. 15, 2021

(54) CONTROL APPARATUSES, MOBILE BODIES, CONTROL METHODS, AND PROGRAMS

(71) Applicant: SZ DJI TECHNOLOGY CO., LTD., Shenzhen (CN)

(72) Inventors: Kenichi HONJO, Shenzhen (CN); Tomonaga YASUDA, Shenzhen (CN)

(73) Assignee: SZ DJI TECHNOLOGY CO., LTD., Shenzhen (CN)

(21) Appl. No.: 17/024,666

(22) Filed: Sep. 17, 2020

Related U.S. Application Data
(63) Continuation of application No. PCT/CN2019/095590, filed on Jul. 11, 2019.

(30) Foreign Application Priority Data
Jul. 13, 2018 (JP) 2018-133302

(51) Int. Cl. G02B 7/08; G03B 13/36; G02B 7/28; G02B 13/00

(52) U.S. Cl. CPC G02B 7/08; G02B 13/009; G02B 7/28; G03B 13/36

(57) ABSTRACT

A control apparatus includes a control unit for controlling a lens system of the photographing apparatus. When a distance from an object-side focus of the lens system to a photographed object changes from a to n×a due to moving of the photographing apparatus, the control unit changes a focal length of the lens system from f to n×f, and changes a distance from an image-side focus of the lens system to an image plane from b to n×b. The lens system has a zoom lens system and a focus lens system. By controlling the zoom lens system, the control unit changes the focal length of the lens system from f to n×f, and by controlling the focus lens system, the control unit changes the distance from the image-side focus of the lens system from b to n×b.

### RELATED APPLICATIONS

The present patent document is a continuation of PCT Application Serial No. PCT/CN2019/095590, filed on Jul. 11, 2019, designating the United States, published in Chinese, and claiming the priority to Japanese Application Serial No. 2018-133302 filed on Jul. 13, 2018, and contents of both applications are herein incorporated by reference in their entirety.

### BACKGROUND

### 1. Technical Field

The present disclosure relates to control apparatuses, mobile bodies, control methods, and programs.

### 2. Background Information

Japanese Patent Application JP2016517639 (A) describes an image analysis used in accordance with camera movement to automatically adjust a zoom function in order to provide a dolly zoom effect.

### BRIEF SUMMARY

The present disclosure provides control methods, control apparatuses mobile bodies and programs that help photographing apparatuses capture images with a dolly zoom effect more easily.

A first aspect of the present disclosure refers to a control apparatus. The control apparatus may comprise a control unit to, when a distance between an object-side focus of the lens system and a photographed object is changed from a first distance a to a second distance n×a due to moving of the photographing apparatus, change a focal length of the lens system from a first focal length f to a second focal length n×f, and change a distance between an image-side focus of the lens system and an image plane from a third distance b to a fourth distance n×b, wherein n is a real number.

In some exemplary embodiments, the lens system may include a zoom lens system and a focus lens system. The control unit may further change the focal length of the lens system to the second focal length n×f by controlling the zoom lens system, and change the distance between the image-side focus of the lens system and the image plane to the fourth distance n×b by controlling the focus lens system.

In some exemplary embodiments, the control unit may further determine a setting-value for focusing of the focus lens system to change the distance between the image-side focus of the lens system and the image plane to the fourth distance n×b based on setting information, wherein the setting information represents the setting-value for focusing in a manner associated with: information corresponding to the focal length of the lens system, and information corresponding to the distance from the object-side focus of the lens system to the photographed object.

In some exemplary embodiments, the control unit may further control the focus lens system when the lens system changes from a first zoom ratio corresponding to the first focal length f to a second zoom ratio corresponding to the second focal length n×f, so that a relationship of n, r₁, r₂, S₁, and S₂ satisfies a predetermined condition, wherein n=Z₁/Z₂, Z is the first zoom ratio, Z₂ is the second zoom ratio, S₁ is a setting-value for focusing of the focus lens system at the first zoom ratio, S₂ is a setting-value for focusing of the focus lens system at the second zoom ratio, r₁ is an amount of movement of the focus lens system that causes the focus lens system to move from an infinitely far side to a nearest side at the first zoom ratio determined based on the setting information, and r₂ is an amount of movement of the focus lens system that causes the focus lens system to move from an infinitely far side to a nearest side at the second zoom ratio determined based on the setting information.

In some exemplary embodiments, the control unit may further control the focus lens system to satisfy S₂=(1/n)×(r₂/r₁)×S₁.

In some exemplary embodiments, the control apparatus may further comprise a determining unit to determine setting-value for focusing of the photographing apparatus for changing the first focal length f of the lens system to the second focal length n×f, and a setting-value for zooming of the photographing apparatus for changing the third distance b from the image-side focus of the lens system to the image plane to the fourth distance n×b, based on: a time required for causing a zoom ratio of the photographing apparatus to change from a first zoom ratio corresponding to the first focal length f to a second zoom ratio corresponding to the second focal length n×f, the first zoom ratio, the second zoom ratio, information indicating the first distance a, and information indicating the second distance n×a.

In some exemplary embodiments, the determining unit may further determine the setting-value for focusing and the setting-value for zooming based on: first information indicating a relationship between a location of the zoom lens system and a location of the focus lens system under the first distance a, and second information indicating a relationship between a location of the zoom lens system and a location of the focus lens system under the second distance n×a.

In some exemplary embodiments, the first distance a may correspond to a distance from the photographing apparatus to a first focus position at which focusing is to be performed at a first time point, and the second distance n×a may correspond to a distance from the photographing apparatus to a second focus position at which focusing is to be performed at a second time point. The determining unit may further determine the setting-value for focusing and the setting-value for zooming, so that a size of an object photographed in the first focus position by the photographing apparatus at the first time point on the image plane and a size of an object photographed in the second focus position by the photographing apparatus at the second time point on the image plane satisfy a predetermined condition.

In some exemplary embodiments, the predetermined condition may be a condition that the size of the object photographed in the first focus position by the photographing apparatus at the first time point on the image plane is consistent with the size of the object photographed in the second focus position by the photographing apparatus at the second time point on the image plane.

A second aspect of the present disclosure refers to a mobile body. The mobile body may comprise a control apparatus; and a photographing apparatus. The control apparatus may comprise a control unit to, when a distance between an object-side focus of the lens system and a photographed object is changed from a first distance a to a second distance n×a due to moving of the photographing apparatus, change a focal length of the lens system from a first focal length f to a second focal length n×f, and change a distance between an image-side focus of the lens system and an image plane from a third distance b to a fourth distance n×b, wherein n is a real number.

In some exemplary embodiments, the lens system may include a zoom lens system and a focus lens system. The control unit may further change the focal length of the lens system to the second focal length n×f by controlling the zoom lens system, and change the distance between the image-side focus of the lens system and the image plane to the fourth distance n×b by controlling the focus lens system.

In some exemplary embodiments, the control unit may further determine a setting-value for focusing of the focus lens system to change the distance between the image-side focus of the lens system and the image plane to the fourth distance n×b based on setting information, wherein the setting information represents the setting-value for focusing in a manner associated with: information corresponding to the focal length of the lens system, and information corresponding to the distance from the object-side focus of the lens system to the photographed object.

In some exemplary embodiments, the control unit may further control the focus lens system when the lens system changes from a first zoom ratio corresponding to the first focal length f to a second zoom ratio corresponding to the second focal length n×f, so that a relationship of n, r₁, r₂, S₁, and S₂ satisfies a predetermined condition, wherein n=Z₁/Z₂, Z₁ is the first zoom ratio, Z₂ is the second zoom ratio, S₁ is a setting-value for focusing of the focus lens system at the first zoom ratio, S₂ is a setting-value for focusing of the focus lens system at the second zoom ratio, r₁ is an amount of movement of the focus lens system that causes the focus lens system to move from an infinitely far side to a nearest side at the first zoom ratio determined based on the setting information, and r₂ is an amount of movement of the focus lens system that causes the focus lens system to move from an infinitely far side to a nearest side at the second zoom ratio determined based on the setting information.

In some exemplary embodiments, the control unit may further control the focus lens system to satisfy S₂=(1/n)×(r₂/r₁)×S₁.

In some exemplary embodiments, the control apparatus may further comprise a determining unit to determine setting-value for focusing of the photographing apparatus for changing the first focal length f of the lens system to the second focal length n×f, and a setting-value for zooming of the photographing apparatus for changing the third distance b from the image-side focus of the lens system to the image plane to the fourth distance n×b, based on: a time required for causing a zoom ratio of the photographing apparatus to change from a first zoom ratio corresponding to the first focal length f to a second zoom ratio corresponding to the second focal length n×f, the first zoom ratio, the second zoom ratio, information indicating the first distance a, and information indicating the second distance n×a.

In some exemplary embodiments, the determining unit may further determine the setting-value for focusing and the setting-value for zooming based on: first information indicating a relationship between a location of the zoom lens system and a location of the focus lens system under the first distance a, and second information indicating a relationship between a location of the zoom lens system and a location of the focus lens system under the second distance n×a.

In some exemplary embodiments, the first distance a may correspond to a distance from the photographing apparatus to a first focus position at which focusing is to be performed at a first time point, and the second distance n×a may correspond to a distance from the photographing apparatus to a second focus position at which focusing is to be performed at a second time point. The determining unit may further determine the setting-value for focusing and the setting-value for zooming, so that a size of an object photographed in the first focus position by the photographing apparatus at the first time point on the image plane and a size of an object photographed in the second focus position by the photographing apparatus at the second time point on the image plane satisfy a predetermined condition.

In some exemplary embodiments, the predetermined condition may be a condition that the size of the object photographed in the first focus position by the photographing apparatus at the first time point on the image plane is consistent with the size of the object photographed in the second focus position by the photographing apparatus at the second time point on the image plane.

In some exemplary embodiments, the control unit may cause the mobile body to move at a predetermined speed, so that the distance between the object-side focus of the lens system and the photographed object is changed from the first distance a to the second distance n×a.

A third aspect of the present disclosure refers to a control method for controlling a lens system of a photographing apparatus. The control method may comprise: when a distance between an object-side focus of the lens system and a photographed object is changed from a to n×a due to moving of the photographing apparatus, changing a focal length of the lens system from f to n×f, and changing a distance between an image-side focus of the lens system and an image plane from b to n×b, wherein n is a real number.

A fourth aspect of the present disclosure refers to a program for causing a computer to function as the aforementioned control device.

The exemplary embodiments of the present disclosure may enable photographing apparatuses to capture images with dolly zoom effects more easily.

In addition, the above summary does not enumerate all the essential features of the present disclosure, in addition, sub-combinations of these feature groups may also fall within the scope of the protection of the present disclosure.

### BRIEF DESCRIPTION OF THE DRAWINGS

To describe the technical solutions in the exemplary embodiments of the present disclosure more clearly, the following briefly describes the accompanying drawings required for describing the exemplary embodiments. Apparently, the accompanying drawings in the following description show some exemplary embodiments of the present disclosure, and persons of ordinary skill in the art may still derive other drawings from these accompanying drawings without creative efforts.

FIG. 1 is a diagram showing exteriors of an unmanned aerial vehicle and a remote operation apparatus according to some exemplary embodiments;

FIG. 2 is a diagram showing functional blocks of an unmanned aerial vehicle according to some exemplary embodiments;

FIG. 3 is a diagram showing a relationship between a location of an unmanned aerial vehicle and a location of a photographed object according to some exemplary embodiments;

FIG. 4 is a diagram showing a relationship between a location of a focus lens and a location of a zoom lens according to some exemplary embodiments;

FIG. 5 is a diagram for describing a focal length of a lens system, a distance from an object-side focus to a photographed object, and a distance from an image-side focus to an image plane;

FIG. 6 is a diagram showing setting information that is associated with a focal length and a focus distance and indicates a setting-value for focusing according to some exemplary embodiments;

FIG. 7 is a diagram showing a relationship between a location of a focus lens and a location of a zoom lens according to some exemplary embodiments;

FIG. 8 is a diagram showing the relationship between a zoom tracking curve and a motion tracking curve according to some exemplary embodiments;

FIG. 9A is a diagram showing an image shot by a photographing apparatus on a telephoto side according to some exemplary embodiments;

FIG. 9B is a diagram showing an image shot by a photographing apparatus on a wide-angle side according to some exemplary embodiments;

FIG. 10A is a diagram showing an image shot by a photographing apparatus on a telephoto side according to some exemplary embodiments;

FIG. 10B is a diagram showing an image shot by a photographing apparatus on a wide-angle side according to some exemplary embodiments;

FIG. 11A is a diagram showing an image shot by a photographing apparatus on a telephoto side according to some exemplary embodiments;

FIG. 11B is a diagram showing an image shot by a photographing apparatus on a wide-angle side according to some exemplary embodiments;

FIG. 12A is a diagram for describing a manner of photographing by combining optical zooming with electronic zooming by a photographing apparatus;

FIG. 12B is a diagram for describing a manner of photographing by combining optical zooming with electronic zooming by a photographing apparatus;

FIG. 12C is a diagram for describing a manner of photographing by combining optical zooming with electronic zooming by a photographing apparatus;

FIG. 13 is a diagram showing a relationship between a location of a focus lens and a location of a zoom lens in a case of combining optical zooming and electronic zooming according to some exemplary embodiments;

FIG. 14 is a diagram showing a location change of a focus lens when electronic zooming is performed after optical zooming according to some exemplary embodiments;

FIG. 15 is a flowchart showing a photographing process of a photographing apparatus according to some exemplary embodiments; and

FIG. 16 is a diagram showing hardware composition according to some exemplary embodiments.

### DESCRIPTION OF SYMBOLS

10 UAV
20 UAV body
30 UAV control unit
31 Obtaining unit
32 Determining unit
33 Judging unit
36 Communication interface
37 Memory
40 Propulsion unit
41 GPS receiver
42 Inertial measurement unit
43 Magnetic compass
44 Barometric altimeter
45 Temperature sensor
46 Humidity sensor
50 Universal joint
60 Photographing apparatus
100 Photographing apparatus
102 Photographing unit
110 Photographing control unit
120 Image sensor
130 Memory
200 Lens unit
210 Focus lens
211 Zoom lens
212 Lens drive unit
213 Lens drive unit
214 Position sensor
215 Position sensor
220 Lens control unit
222 Memory
300 Remote operation apparatus
1200 Computer
1210 Host controller
1212 CPU
1214 RAM
1220 Input/output controller
1222 Communication interface
1230 ROM

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined. The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some embodiments, numbers expressing quantities or properties used to describe or define the embodiments of the present application should be understood as being modified by the terms “about” “generally”, “approximate,” or “substantially” in some instances. For example, “about”, “generally”, “approximately” or “substantially” may mean a ±20% change in the described value unless otherwise stated. Accordingly, in some embodiments, the numerical parameters set forth in the written description and the appended claims are approximations, which may vary depending upon the desired properties sought to be obtained in a particular embodiment. In some embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

The following describes the present disclosure by using implementations of the present disclosure. However, the following implementations do not limit the claims. In addition, all feature combinations described in the implementations are not necessarily mandatory for solutions of the present disclosure. For a person of ordinary skill in the art, various variations or improvements may be made to the following implementations. Obviously, from the descriptions of the claims, any manner of such variations or improvements may be included in the technical scope of the present disclosure.

The claims, the specification, the accompanying drawings, and the abstract contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Each implementation of the present disclosure may be described with reference to the flowchart and block diagram. Herein the block may indicate (1) a stage of a process of performing an operation or (2) a “unit” of an apparatus having a function of performing an operation. The specified stage and “unit” may be implemented by using a programmable circuit and/or a processor. A dedicated circuit may include a digital and/or analog hardware circuit and may include an integrated circuit (IC) and/or a discrete circuit. The programmable circuit may include a reconfigurable hardware circuit. The reconfigurable hardware circuit may include logic AND, logic OR, logic XOR, logic NAND, logic NOR, and other logic operations, and storage elements such as a trigger, a register, a field programmable gate array (FPGA), and a programmable logic array (PLA).

A computer-readable medium may include any tangible device that may store an instruction executed by an appropriate device. As a result, the computer-readable medium storing an instruction may include a product including an instruction, where the instruction may be executed to create a means for performing an operation specified by the flowchart or block diagram. An example of the computer-readable medium may include an electronic storage medium, a magnetic storage medium, an optical storage medium, an electromagnetic storage medium, a semiconductor storage medium, or the like. A more specific example of the computer-readable medium may include a Floppy™ disk, a diskette, a hard disk, a random access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disc (DVD), a Blu-ray (RTM) disc, a memory stick, an integrated circuit card, or the like.

A computer-readable instruction may include any one of source code or target code described by any combination of one or more programming languages. The source code or the target code may include a conventional program-mode programming language. The conventional program-mode programming language may be an object-oriented programming language and a “C” programming language or a similar programming language, for example, an assembly instruction, an instruction set architecture (ISA) instruction, a machine instruction, a machine-related instruction, a micro code, a firmware instruction, status setting data, or Smalltalk, JAVA®, or C++. The computer-readable instruction may be provided locally or provided through a local area network (LAN) or a wide area network (WAN) such as the Internet to a processor or programmable circuit of a general-purpose computer, a dedicated computer, or another programmable data processing apparatus. The processor or programmable circuit may execute the computer-readable instruction to create a means for performing an operation specified by the flowchart or block diagram. An example of the processor may include a computer processor, a processing unit, a microprocessor, a digital signal processor, a controller, a microcontroller, or the like.

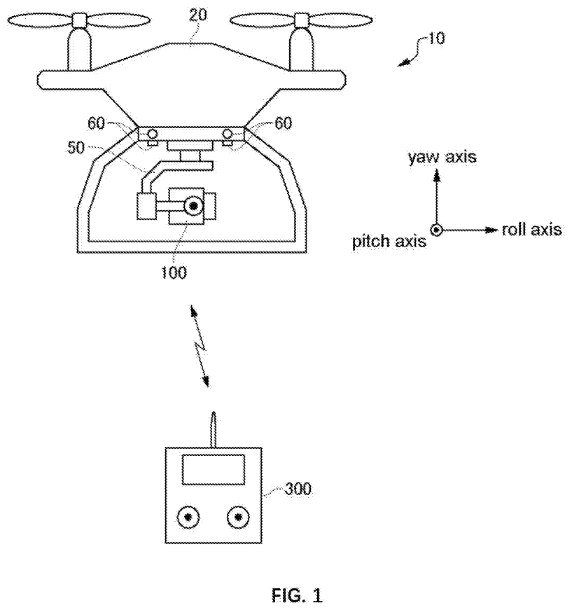

FIG. 1 shows exteriors of an unmanned aerial vehicle (UAV) 10 and a remote operation apparatus 300 according to some exemplary embodiments. The UAV 10 may include a UAV body 20, a universal joint 50, a plurality of photographing apparatuses 60, and a photographing apparatus 100. The universal joint 50 and the photographing apparatus 100 may be an example of a photographing system. The UAV 10, that is, a mobile body, may include concepts such as a flying body moving in the air, a vehicle moving on the ground, and a ship moving on water. The flying body moving in the air may include not only the UAV but also other concepts such as an aircraft, an airship, and a helicopter.

The UAV body 20 may include a plurality of rotors. The plurality of rotors may be an example of a propulsion unit. The UAV body 20 may enable the UAV 10 to fly by controlling the rotation of the plurality of rotors. The UAV body 20 may use, for example, four rotors, to enable the UAV 10 to fly. However, the number of rotors may not be limited to four. In addition, the UAV 10 may also be a fixed-wing aircraft without rotors.

The photographing apparatus 100 may be a camera for photographing an object in an expected photographing range. The universal joint 50 may rotatably support the photographing apparatus 100. The universal joint 50 may be an example of a support mechanism. For example, the universal joint 50 supports the photographing apparatus 100, so that the photographing apparatus 100 can rotate around a pitch axis by using an actuator. The universal joint 50 may support the photographing apparatus 100 so that the photographing apparatus 100 can further rotate around a roll axis and a yaw axis respectively by using the actuator. The universal joint 50 may change a posture of the photographing apparatus 100 by causing the photographing apparatus 100 to rotate around at least one of the yaw axis, the pitch axis, and the roll axis.

The plurality of photographing apparatuses 60 may be cameras for sensing and photographing a vicinity of the UAV 10 to control the flight of the UAV 10. Two photographing apparatuses 60 may be disposed on a head, i.e., a front side of the UAV 10. In addition, two other photographing apparatuses 60 may be disposed on a bottom side of the UAV 10. The two photographing apparatuses 60 on the front side may be paired, and play a role of a stereoscopic camera. The two photographing apparatuses 60 on the bottom side may also be paired, and play a role of a stereoscopic camera. Three-dimensional space data around the UAV 10 may be generated based on images shot by the plurality of photographing apparatuses 60. The quantity of photographing apparatuses 60 included in the UAV 10 is not limited to four. The UAV 10 may need to include at least one photographing apparatus 60. In some exemplary embodiments, the UAV 10 may include at least one photographing apparatus 60 on each of the head, tail, lateral side, bottom side, and top side of the UAV 10. An angle of view that can be set in the photographing apparatus 60 may be greater than an angle of view that can be set in the photographing apparatus 100. The photographing apparatus 60 may also have a single focus lens or a fisheye lens.

The remote operation apparatus 300 may communicate with the UAV 10, to remotely operate the UAV 10. The remote operation apparatus 300 may perform wireless communication with the UAV 10. The remote operation apparatus 300 may send, to the UAV 10, indication information of various instructions about moving of the UAV 10, for example, ascending, descending, accelerating, decelerating, moving forward, moving backward, or rotating. The indication information may include, for example, information causing the UAV 10 to ascend. The indication information may show a height at which the UAV 10 should be located. The UAV 10 may move to the height indicated by the indication information received from the remote operation apparatus 300. The indication information may include an ascending instruction causing the UAV 10 to ascend. The UAV 10 may ascend when accepting ascending instruction. When the height of the UAV 10 has reached an upper height limit, even if the ascending instruction is accepted, ascending of the UAV 10 may be limited.

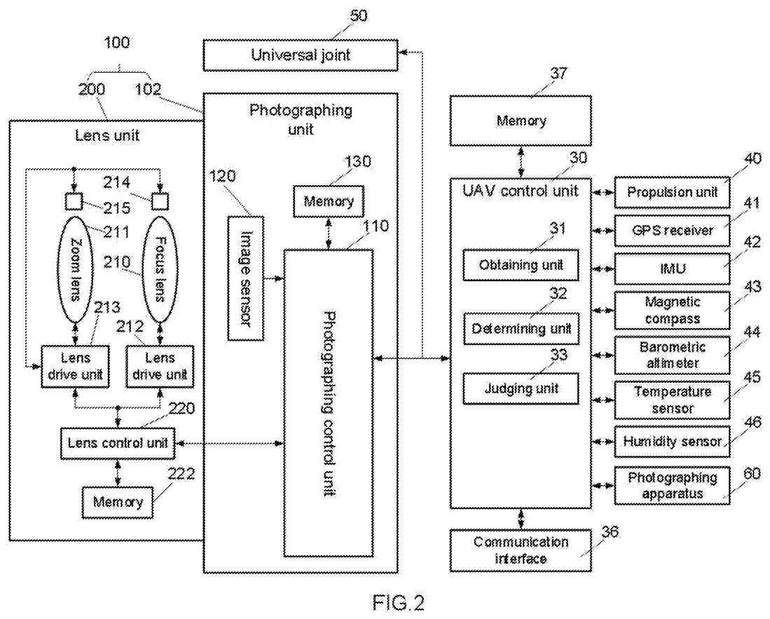

FIG. 2 shows functional blocks of a UAV 10 according to some exemplary embodiments. The UAV 10 may include a UAV control unit 30, a memory 37, a communication interface 36, a propulsion unit 40, a GPS receiver 41, an inertial measurement unit 42, a magnetic compass 43, a barometric altimeter 44, a temperature sensor 45, a humidity sensor 46, a universal joint 50, a photographing apparatus 60, and a photographing apparatus 100.

The communication interface 36 may communicate with other apparatuses such as a remote operation apparatus 300. The communication interface 36 may receive, from the remote operation apparatus 300, indication information of various instructions for the UAV control unit 30. The memory 37 may store programs required for the UAV control unit 30 to control the propulsion unit 40, the GPS receiver 41, the inertial measurement unit (IMU) 42, the magnetic compass 43, the barometric altimeter 44, the temperature sensor 45, the humidity sensor 46, the universal joint 50, the photographing apparatus 60, and the photographing apparatus 100. The memory 37 may be a computer-readable recording medium and may include at least one of the flash memories such as an SRAM, a DRAM, an EPROM, an EEPROM, a USB memory, and a solid-state disk (SSD). The memory 37 may be disposed in a UAV body 20. The memory 37 may be detachably disposed on the UAV body 20.

The UAV control unit 30 may control flight and photographing of the UAV 10 based on a program stored in the memory 37. The UAV control unit 30 may include a microprocessor such as a CPU or an MPU, and a microcontroller such as an MCU. The UAV control unit 30 may control flight and photographing of the UAV 10 according to an instruction received from the remote operation apparatus 300 through the communication interface 36. The propulsion unit 40 may propel the UAV 10. The propulsion unit 40 may include a plurality of rotors and a plurality of drive motors causing the plurality of rotors to rotate. The propulsion unit 40 may cause the UAV 10 to fly by causing the plurality of rotors to rotate through the plurality of drive motors according to an instruction from the UAV control unit 30.

The GPS receiver 41 may receive a plurality of time signals sent by a plurality of GPS satellites. The GPS receiver 41 may calculate, based on the plurality of received signals, a location (e.g., latitude and longitude) of the GPS receiver 41, that is, a location (e.g., latitude and longitude) of the UAV 10. The IMU 42 may detect a posture of the UAV 10. The IMU 42 may detect the acceleration in front-back, left-right, and up-down tri-axis directions of the UAV 10, and angular speeds in tri-axis directions of a pitch axis, a roll axis, and a yaw axis, and use them as the posture of the UAV 10. The magnetic compass 43 may detect an azimuth of a head of the UAV 10. The barometric altimeter 44 may detect a flight height of the UAV 10. The barometric altimeter 44 may detect a height by detecting air pressure around the UAV 10 and converting the detected air pressure into the height. The temperature sensor 45 may detect the temperature around the UAV 10. The humidity sensor 46 may detect the humidity around the UAV 10.

The photographing apparatus 100 may include a photographing unit 102 and a lens unit 200. In addition to optical zooming, the photographing apparatus 100 may further have an electronic zooming function. The photographing apparatus 100 may have at least one of the optical zooming function and the electronic zooming function. The lens unit 200 may be an example of a lens apparatus. The photographing unit 102 may include an image sensor 120, a photographing control unit 110, and a memory 130. The image sensor 120 may include a CCD or a CMOS. The image sensor 120 may shoot an optical image formed by the lens unit 200, and output the shot image to the photographing control unit 110. The photographing control unit 110 may include a microprocessor such as a CPU or an MPU, and a microcontroller such as an MCU. The photographing control unit 110 may control the photographing apparatus 100 according to an action instruction from the UAV control unit 30 for the photographing apparatus 100. The photographing control unit 110 may magnify an image output from the image sensor 120 and cut a part of the image, so as to implement electronic zooming.

The memory 130 may be a computer-readable recording medium and may include at least one of the flash memories such as an SRAM, a DRAM, an EPROM, an EEPROM, a USB memory, and a solid-state disk (SSD). The memory 130 may store a program required for the photographing control unit 110 to control the image sensor 120 and the like. The memory 130 may be disposed in a housing of the photographing apparatus 100. The memory 130 may be detachably disposed on the housing of the photographing apparatus 100.

The lens unit 200 may include a focus lens 210, a zoom lens 211, a lens drive unit 212, a lens drive unit 213, and a lens control unit 220. The focus lens 210 may be an example of a focus lens system. The zoom lens 211 may be an example of a zoom lens system. Each of the focus lens 210 and the zoom lens 211 may include at least one lens. At least a part or all of the focus lens 210 and the zoom lens 211 may be configured to move along an optical axis. The lens unit 200 may be disposed as a replaceable lens that can be dismounted/mounted, relative to the photographing unit 102. By using a mechanical component such as a cam ring or a leading axle, the lens drive unit 212 may cause at least one part or all of the focus lens 210 to move along an optical axis. By using a mechanical component such as a cam ring or a leading axle, the lens drive unit 213 may cause at least one part or all of the zoom lens 211 to move along an optical axis. The lens control unit 220 may drive, according to a lens control instruction from the photographing unit 102, at least one of the lens drive unit 212 and the lens drive unit 213, and cause, by using a mechanism component, at least one of the focus lens 210 and the zoom lens 211 to move along a direction of the optical axis, so as to perform at least one of a zooming action and a focusing action. The lens control instruction may be, for example, a zoom control instruction and a focus control instruction.

The lens unit 200 may further include a memory 222, a position sensor 214, and a position sensor 215. The memory 222 may store control values of the focus lens 210 and the zoom lens 211 that move by using the lens drive unit 212 and the lens drive unit 213. The memory 222 may include at least one of the flash memories such as an SRAM, a DRAM, an EPROM, an EEPROM, and a USB memory. The position sensor 214 may detect a lens position of the focus lens 210. The position sensor 214 may detect a current focus position. The position sensor 215 may detect a lens position of the zoom lens 211. The position sensor 215 may detect a current zoom position of the zoom lens 211.

In the photographing apparatus 100 carried on the UAV 10, during moving of the UAV 10, a zooming function of the photographing apparatus 100 is configured to provide a dolly zoom effect for a dynamic image, for example, maintaining a size of a photographed object of interest on an image plane while changing a size of a background on the image plane.

The UAV control unit 30 may include an obtaining unit 31, a determining unit 32, and a judging unit 33. The obtaining unit 31 may obtain time T required for causing a zoom ratio of the photographing apparatus 100 to change from a first zoom ratio to a second zoom ratio, the first zoom ratio, and the second zoom ratio. The obtaining unit 31 may obtain the time, the first zoom ratio, and the second zoom ratio that are prestored in the memory 130 or the memory 37 or the like. The obtaining unit 31 may obtain, by using the remote operation apparatus 300, the time T, the first zoom ratio, and the second zoom ratio that are specified by a user.

The zoom ratio may be an optical zoom ratio, an electronic zoom ratio, or a ratio combining an optical zoom ratio and an electronic zoom ratio. The optical zoom ratio may be a ratio starting from a wide-angle end. The electronic zoom ratio may be a magnification ratio of an image output by the image sensor 120.

Based on the time T, the first zoom ratio, and the second zoom ratio, the determining unit 32 may determine a setting-value for focusing of the photographing apparatus 100, a setting-value for zooming of the photographing apparatus 100, and a moving speed of the UAV 10 at each time point from the first time point to the second time point. Based on information indicating a first focus distance of the photographing apparatus 100 at the first time point and information indicating a second focus distance of the photographing apparatus 100 at the second time point, the determining unit 32 may further determine a setting-value for focusing of the photographing apparatus 100, a setting-value for zooming of the photographing apparatus, and a moving speed of the UAV 10 at each time point from the first time point to the second time point. Herein the information indicating the first focus distance may include at least one of a distance from the photographing apparatus 100 to a photographed object that enters a focusing state at the first time point and a location of the focus lens 210 that causes the photographed object to enter the focusing state at the first time point. The information indicating the second focus distance may include at least one of a distance from the photographing apparatus 100 to a photographed object that enters a focusing state at the second time point and a location of the focus lens 210 that causes the photographed object to enter the focusing state at the second time point. The focusing state is, for example, a state in which an estimated value of a contrast ratio of the photographed object in an image may be greater than or equal to a predetermined value.

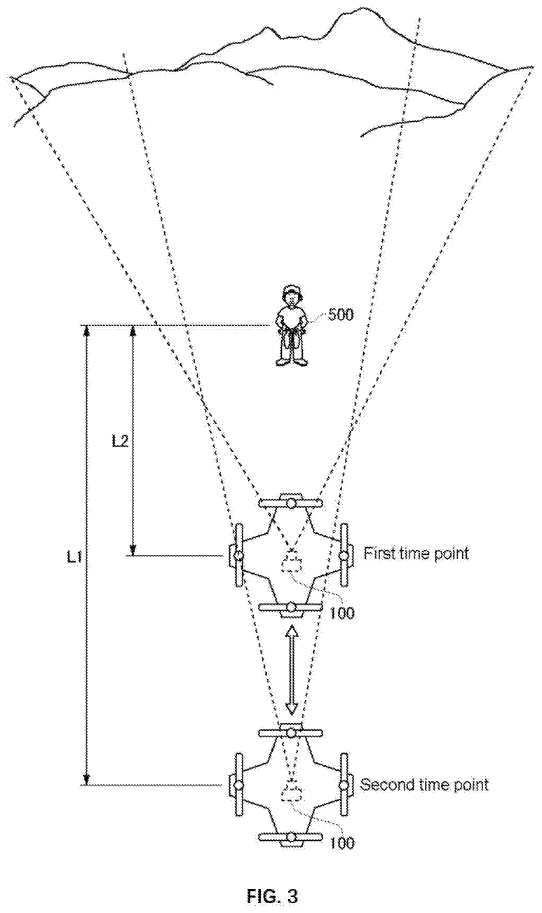

For example, the first zoom ratio is 2, and the second zoom ratio may be 1. As shown in FIG. 3, it is assumed that the zoom ratio of the photographing apparatus 100 at the first time point is 2, and that a distance (a first focus distance) from the photographing apparatus 100 to a photographed object 500 is L1. In addition, the UAV 10 may be configured to move along a photographing direction, so that a size of the photographed object 500 on an image plane when the zoom ratio is 2 is consistent with a size of the photographed object 500 on the image plane when the zoom ratio is 1. In this case, because the zoom ratio of the photographing apparatus 100 at the second time point is 1, a distance (e.g., a second focus distance) from the photographing apparatus 100 to the photographed object 500 is L2 (=L1/2). For example, the UAV 10 may move a difference (L1−L2=L1) between the first focus distance and the second focus distance along the photographing direction.

The photographing apparatus 100 may cause the zoom lens 211 to move from the first time point to the second time point, so as to cause the zoom ratio to change from 2 to 1. In addition, from the first time point to the second time point, the photographing apparatus 100 may cause a focus distance of the focus lens 210 to change from the first focus distance to the second focus distance. The first focus distance may correspond to a distance from the photographing apparatus 100 to a first focus position in which focusing should be performed at the first time point. The second focus distance may correspond to a distance from the photographing apparatus 100 to a second focus position in which focusing should be performed at the second time point. In addition, instead of moving close to the photographed object 500, the photographing apparatus 100 may move away from the photographed object 500. In this case, for example, the first zoom ratio may be 1, and the second zoom ratio may be 2.

The photographing apparatus 100 may perform photographing in a manner of maintaining a focusing state of a single stationary photographed object from the first time point to the second time point. In this case, the first focus position and the second focus position are the same. The photographing apparatus 100 may focus a first photographed object at the first time point, and perform photographing in a manner of focusing a second photographed object whose distance from the photographing apparatus 100 is different from that of the first photographed object. In this case, the first focus position and the second focus position may be different.

The determining unit 32 may determine a moving speed of the UAV 10 that is required for moving a difference between the second focus distance and the first focus distance by the UAV 10 during the time T.

Based on first information indicating a relationship between a location of the zoom lens and a location of the focus lens in the first focus distance, and second information indicating a relationship between a location of the zoom lens and a location of the focus lens in the second focus distance, the determining unit 32 may determine a setting-value for focusing of the photographing apparatus 100 and a setting-value for zooming of the photographing apparatus 100 at each time point from the first time point to the second time point.

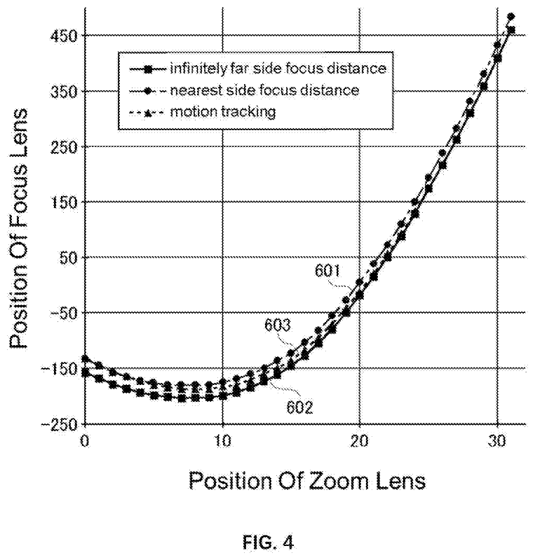

Based on a zoom tracking curve, the determining unit 32 may determine a setting-value for focusing of the photographing apparatus 100 and a setting-value for zooming of the photographing apparatus 100 at each time point from the first time point to the second time point. For example, as shown in FIG. 4, the determining unit 32 may determine a motion tracking curve 603 based on a zoom tracking curve 602 of an infinitely far side focus distance corresponding to the first focus distance and a zoom tracking curve 601 of a nearest side focus distance corresponding to the second focus distance, where the motion tracking curve 603 indicates a setting-value for focusing of the photographing apparatus 100 and a setting-value for zooming of the photographing apparatus 100 at each time point from the first time point to the second time point. The photographing control unit 110 outputs a zooming action instruction and a focusing action instruction to the lens control unit 220, to control the location of the zoom lens and the location of the focus lens from the first time point to the second time point based on the motion tracking curve 603 shown in FIG. 4.

The determining unit 32 may obtain data of a zoom tracking curve of each focus distance stored in the memory 222 of the lens unit 200, and determine a motion tracking curve based on the obtained data, where the motion tracking curve may indicate a setting-value for focusing of the photographing apparatus 100 and a setting-value for zooming of the photographing apparatus 100 at each time point from the first time point to the second time point.

When the photographing apparatus 100 shoots a dynamic image generating a dolly zoom effect, the UAV 10 may fly along the photographing direction of the photographing apparatus 100 from the first time point to the second time point. The photographing control unit 110 may control the zoom lens 211 and the focus lens 210 from the first time point to the second time point so that the photographing apparatus 100 maintains a size of an object photographed in a first position in a focusing state at the first time point on an image plane and a state of focusing the photographed object in the first position. The determining unit 32 may determine a setting-value for focusing of the photographing apparatus 100 at each time point from the first time point to the second time point.

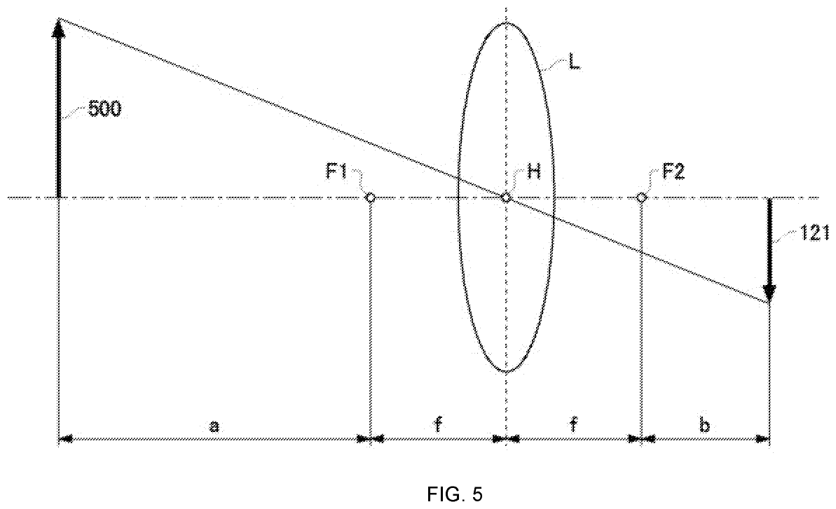

FIG. 5 is a diagram of a lens system L configured to represent the focus lens 210 and the zoom lens 211. H may indicate a principal point of the lens system L; F1 may indicate an object-side focus of the lens system L; F2 may indicate an image-side focus of the lens system L; f may indicate a distance from the principal point H to the object-side focus F1 or the image-side focus F2, that is, a focal length; a may indicate a distance from the object-side focus F1 to the photographed object 500; and b may indicate a distance from the image-side focus F2 to an image plane 121. In this case, according to Newton's imaging equation, a, b, and f may satisfy the following relationship, where each of a, b, and f is a real number:

b=f²×(1/a).

The first zoom ratio at the first time point may be set to Z₁; following the first zoom ratio, a second zoom ratio at a next time point may be set to Z₂; and a ratio of the first zoom ratio Z1 to the second zoom ratio Z2 may be set to n=Z₁/Z₂. When the photographing apparatus 100 causes the zoom ratio to change from the first zoom ratio Z₁ to the second zoom ratio Z₂, the UAV control unit 30 may control the UAV 10 to change the distance a to a distance n×a. By using the lens control unit 220, the photographing control unit 110 controls the zoom lens 211 to change the focal length f to a focal length n×f.

According to the Newton's imaging equation, a distance b′ at the second zoom ratio Z₂ may be expressed as follows:

b′=(n×f)²×(1/(n×a))=n×f²×(1/a)=n×b.

To be specific, when the photographing apparatus 100 causes the zoom ratio to change from the first zoom ratio Z₁ to the second zoom ratio Z₂, the photographing control unit 110 may only need to control the focus lens 210 to change the distance from the image-side focus of the lens system L to the image plane to n×b. When the distance a from the object-side focus of the lens system L to the photographed object is changed to n×a, the UAV control unit 30 may control the zoom lens 211 and the focus lens 210 by using the lens control unit 220, so that the focal length f of the lens system L is n×f, and that the distance b from the image-side focus of the lens system L to the image plane is n×b. The UAV control unit 30 may control the zoom lens 211 to change the focal length of the lens system L to n×f, and control the focus lens 210 to change the distance from the image-side focus of the lens system L to the image plane to n×b. Therefore, when the photographing apparatus 100 maintains the size of the object photographed in the first position in the focusing state at the first time point on the image plane and the state of focusing the photographed object in the first position, the photographing apparatus 100 can photograph the object.

Based on the time T required for causing the zoom ratio of the photographing apparatus 100 to change from the first zoom ratio corresponding to the focal length f to the second zoom ratio corresponding to the focal length n×f, the first zoom ratio, the second zoom ratio, information indicating the distance a, and information indicating the distance n×a, the determining unit 32 may determine a setting-value for focusing and a setting-value for zooming that are used for changing the focal length f of the lens system L to n×f and changing the distance b from the image-side focus of the lens system L to the image plane to n×b.

Based on first information indicating a relationship between a location of the zoom lens 211 and a location of the focus lens 210 in the distance a, and second information indicating a relationship between a location of the zoom lens and a location of the focus lens in the distance n×a, the determining unit 32 may further change the focal length f of the lens system L to n×f, and determine a setting-value for focusing and a setting-value for zooming that are used for changing the distance b from the image-side focus of the lens system L to the image plane to n×b.

Based on first information indicating a relationship between a location of the zoom lens 211 and a location of the focus lens 210 in the distance a, and second information indicating a relationship between a location of the zoom lens 211 and a location of the focus lens 210 in the distance n×a, the determining unit 32 may further determine a setting-value for focusing and a setting-value for zooming that are used for changing the focal length f of the lens system L to n×f and changing the distance b from the image-side focus of the lens system L to the image plane to n×b.

The distance a may correspond to the distance from the photographing apparatus 100 to the first focus position in which focusing should be performed at the first time point. The distance n×a may correspond to the distance from the photographing apparatus 100 to the second focus position in which focusing should be performed at the second time point. In this case, the determining unit 32 may determine the setting-value for focusing and the setting-value for zooming that are used for changing the focal length f of the lens system L to n×f and changing the distance b from the image-side focus of the lens system L to the image plane to n×b, so that a size of an object photographed in the first focus position by the photographing apparatus 100 at the first time point on an image plane and a size of an object photographed in the second focus position by the photographing apparatus 100 at the second time point on an image plane satisfy a predetermined condition. The predetermined condition may be a condition that the size of the object photographed in the first focus position by the photographing apparatus 100 at the first time point on the image plane is consistent with the size of the object photographed in the second focus position by the photographing apparatus 100 at the second time point on the image plane.

The lens system L may actually include a plurality of lenses used as zoom lenses 211 or focus lenses 210 to implement functions. When the location of the zoom lens 211 changes, the distance b from the image-side focus of the lens system L to the image plane may also change. According to the change of the location of the zoom lens 211, the photographing apparatus 100 may cause the location of the focus lens 210 to change based on the change of the location of the zoom lens 211, so that the focus distance does not deviate. For example, the photographing apparatus 100 may perform zoom tracking control.

Based on setting information that is associated with the information corresponding to the focal length of the lens system L and the information corresponding to the distance a (e.g., focus distance) from the object-side focus of the lens system L to the photographed object and indicates the setting-value for focusing of the focus lens 210, the determining unit 32 may determine the setting-value for focusing of the focus lens 210 that is used for changing the distance from the image-side focus of the lens system L to the image plane to n×b. The setting information may be information referenced when the photographing control unit 110 performs zoom tracking control.

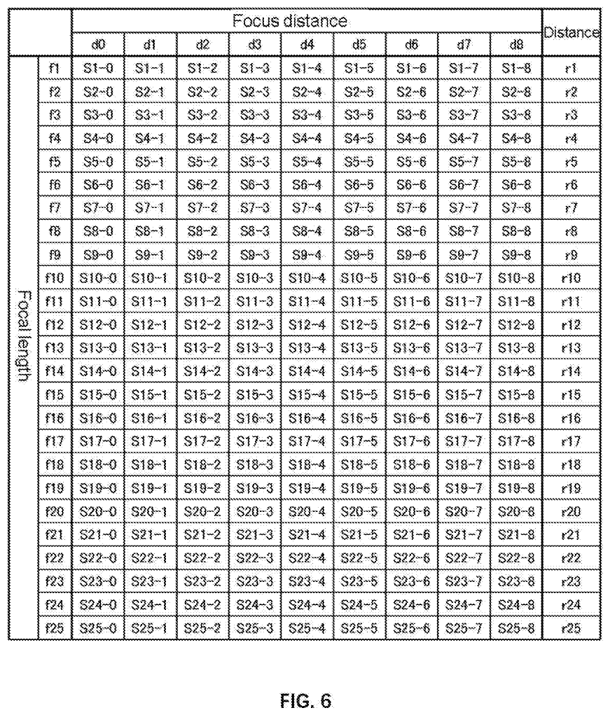

FIG. 6 shows setting information according to some exemplary embodiments. A focus distance d0 may indicate, for example, an infinitely far end. A focus distance d8 may indicate a nearest end. The setting information may be associated with the focal length and the distance a, and show the number of pulses for a stepper motor to drive the focus lens 210 as a setting-value S for the focus lens 210. A distance Range may indicate an amount r of movement of the focus lens 210 with a specific focal length (e.g., zoom ratio) when the focus lens 210 is caused to move from an infinitely far side to a nearest side. Based on a value of the focal length (e.g., zoom ratio), the amount of movement of the focus lens 210 may change when the focus lens 210 is caused to move from the infinitely far side to the nearest side. The memory 130 may also store the setting information shown in FIG. 6. The memory 130 may store a setting-value for focusing of the focus lens 210 with each focal length corresponding to a specific focus distance, as setting information. In this case, the determining unit 32 may also derive, based on the setting information, setting-values for focusing of the focus lens 210 with specific focal lengths (e.g., zoom ratios) in other focus distances separately. The memory 130 may store, for example, a setting-value for focusing of each focal length corresponding to the infinitely far end, that is, information corresponding to a zoom tracking curve of the infinitely far end, as setting information. The determining unit 32 may derive, based on the setting information corresponding to the zoom tracking curve of the infinitely far end, setting-values for focusing of the focus lens 210 with specific focal lengths (e.g., zoom ratios) in other focus distances separately.

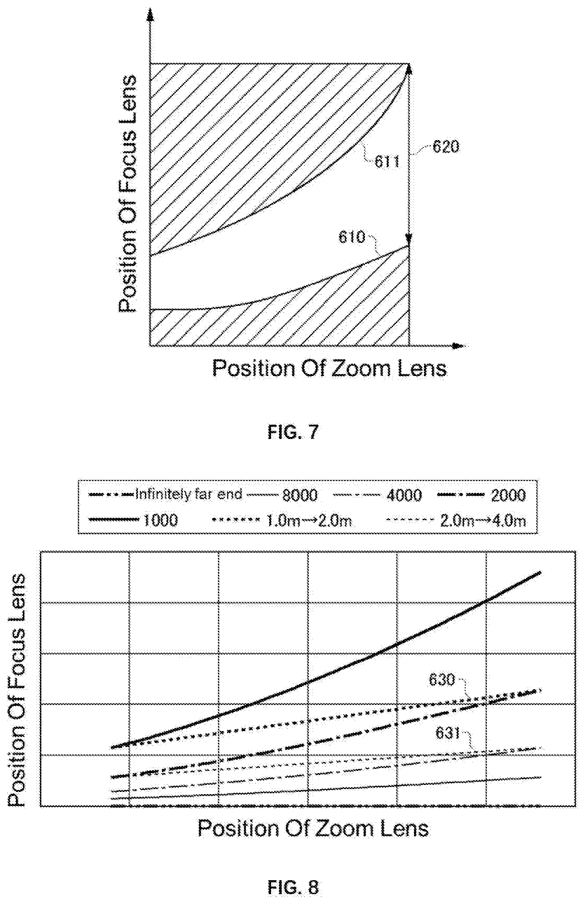

FIG. 7 indicates a set of zoom tracking curves of setting information denoted in a two-dimensional mode. A lower boundary denoted by a symbol 610 may correspond to a zoom tracking curve indicating a relationship between a location (e.g., setting-value for zooming) of the zoom lens 211 and a location (e.g., setting-value for focusing) of the focus lens 210 when the focus distance is the infinitely far end, and an upper boundary denoted by a symbol 611 may correspond to a zoom tracking curve indicating a relationship between a location (e.g., setting-value for zooming) of the zoom lens 211 and a location (e.g., setting-value for focusing) of the focus lens 210 when the focus distance is the nearest end. A width 620 between the zoom tracking curve 610 and the zoom tracking curve 611 may correspond to the amount r of movement of the focus lens 210 when the focus lens 210 is caused to move from the infinitely far side to the nearest side at its zoom ratio.

From the first time point to the second time point, the photographing apparatus 100 causes the zoom ratio of the lens system to change from the first zoom ratio to the second zoom ratio. In this case, the first zoom ratio may be set to Z₁, the second zoom ratio may be set to Z₂, and a ratio of the first zoom ratio to the second zoom ratio is set to n=Z₂/Z₁. The setting-value for focusing of the focus lens 210 at the first zoom ratio Z₁ may be set to S₁, and the setting-value for focusing of the focus lens 210 at the second zoom ratio Z₂ may be set to S₂. Further, an amount of movement (e.g., range) of the focus lens 210 when the focus lens 210 is caused to move from the infinitely far side to the nearest side at the first zoom ratio Z₁ and which is determined based on the setting information shown in FIG. 7 and referenced in zoom tracking control may be set to r₁. In addition, an amount of movement of the focus lens 210 when the focus lens 210 is caused to move from the infinitely far side to the nearest side at the second zoom ratio Z₂ and which is determined based on the setting information may be set to r₂.

In this case, the determining unit 32 may determine S₂ based on n, r₁, r₂, and S₁. Herein the focus distance at the first time point may be set to d1, and a reciprocal of the focus distance d₁ may be set to P₁; the focus distance at the second time point may be set to d₂, and a reciprocal of the focus distance d₂ may be set to P₂; and the focus distance of the nearest end may be set to dₙ, and a constant may be set to div. Herein n, r₁, r₂, S₁, S₂, d₁, d₂, P₁, P₂, dₙ, and div may be real numbers.

In this case, the following equations can be defined.

P1=div(S1/r1) (1)

P1=div(dn/d1) (2)

P2=div(S2/r2) (3)

P2=div(dₙ/d₂) (4)

The equation (3) can be written as:

S₂=(r₂×P₂)/div (5)

By substituting the equation (4) into the equation (5), the following equation can be obtained:

S₂=r₂×div(dₙ/d₂)/div=(dₙ/d₂)×r₂ (6)

Because d₂=n×d₁, the equation (6) can be written as:

S₂=dₙ/(n×d₁)×r₂ (7)

In addition, by using the equation (1) and the equation (2), dₙ/d₁ can be determined as:

dₙ/d₁=S₁/r₁ (8)

By substituting the equation (8) is substituted into the equation (7), the following equation can be obtained:

S₂=(1/n)×(r₂/r₁)×S₁ (9)

Therefore, the determining unit 32 may determine S2 according to S₂=(1/n)×(r₂/r₁)×S₁. The UAV control unit 30 may instruct the photographing apparatus 100 to control the focus lens 210 based on S₂. The UAV control unit 30 may control the focus lens 210 by using the lens control unit 220, so that a relationship between n, r₁, r₂, S₁, and S₂ satisfies a predetermined condition. The UAV control unit 30 may control the focus lens 210 by enabling the lens control unit 220, to satisfy S₂=(1/n)×(r₂/r₁)×S₁.

FIG. 8 shows a zoom tracking curve of each focus distance, a motion tracking curve 630 when the focus distance changes from 1.0 m to 2.0 m, and a motion tracking curve 631 when the focus distance changes from 2.0 m to 4.0 m, according to some exemplary embodiments. During moving of the photographing apparatus 100, the lens control unit 220 may control the focus lens 210 and the zoom lens 211 based on, for example, the motion tracking curve 630 or the motion tracking curve 631.

The determining unit 32 may determine a setting-value for focusing of the photographing apparatus 100, a setting-value for zooming of the photographing apparatus 100, and a moving speed of the UAV 10 at each time point from the first time point to the second time point, so that a size of an object photographed in the first focus position by the photographing apparatus 100 at the first time point on an image plane and a size of an object photographed in the second focus position by the photographing apparatus 100 at the second time point on an image plane satisfy a predetermined condition. The predetermined condition may be a condition that the size of the object photographed in the first focus position by the photographing apparatus 100 at the first time point on the image plane is consistent with the size of the object photographed in the second focus position by the photographing apparatus 100 at the second time point on the image plane.

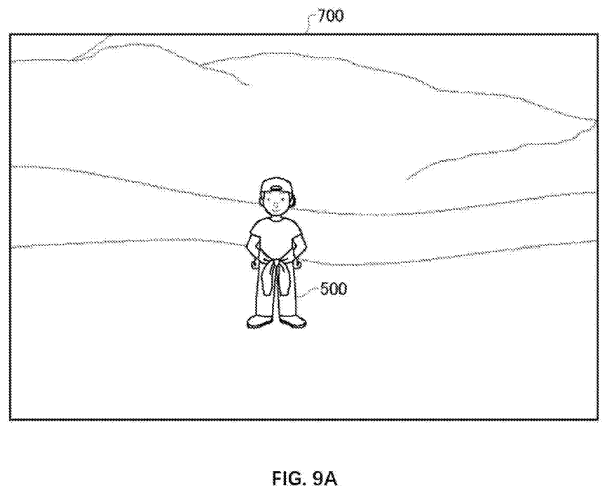

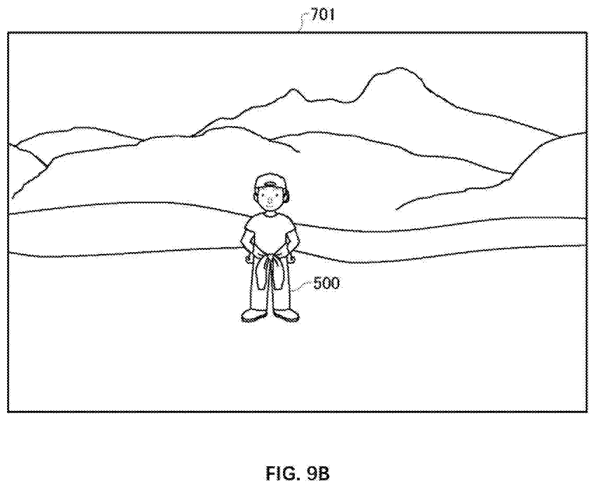

The photographing apparatus 100 may perform photographing in a manner of approaching the photographed object from the first time point to the second time point. When the first focus position and the second focus position are the same, the photographing apparatus 100 may perform photographing during moving relative to the photographed object, so that the first focus distance is longer than the second focus distance. In this case, for example, the photographing apparatus 100 may shoot, at the first time point, an image 700 shown in FIG. 9A at the first focus distance and the first zoom ratio, and shoot, at the second time point, an image 701 shown in FIG. 9B at the second focus distance and the second zoom ratio less than the first zoom ratio. Therefore, a dynamic image shot from the first time point to the second time point may include a representation of maintaining a size of the photographed object 500 of interest on an image plane when the size of the background changes on the image plane.

When the first focus position is different from the second focus position, the determining unit 32 may determine a setting-value for focusing of the photographing apparatus 100, a setting-value for zooming of the photographing apparatus 100, and a moving speed of the UAV 10 at each time point from the first time point to the second time point, so that a size of an object photographed in the first focus position by the photographing apparatus 100 at the first time point on an image plane and a size of an object photographed in the second focus position by the photographing apparatus 100 at the second time point on an image plane satisfy a predetermined condition. Under this condition, a dynamic image shot from the first time point to the second time point may include a representation of changing from a state of focusing a first photographed object of interest that exists in the first focus position at the first time point to a state of focusing a second photographed object of interest that exists in the second focus position at the second time point when the size of the background changes on the image plane.

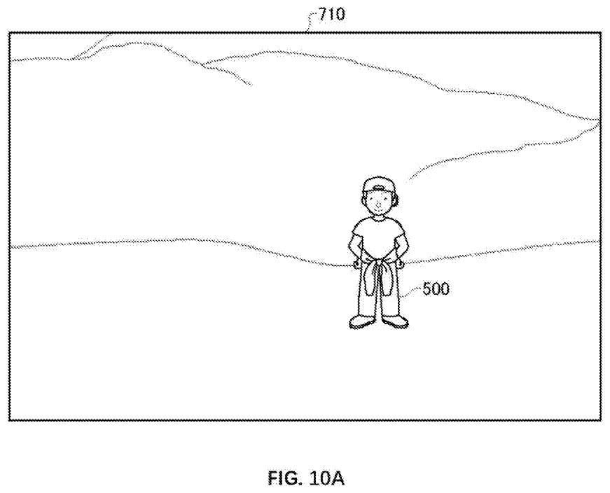

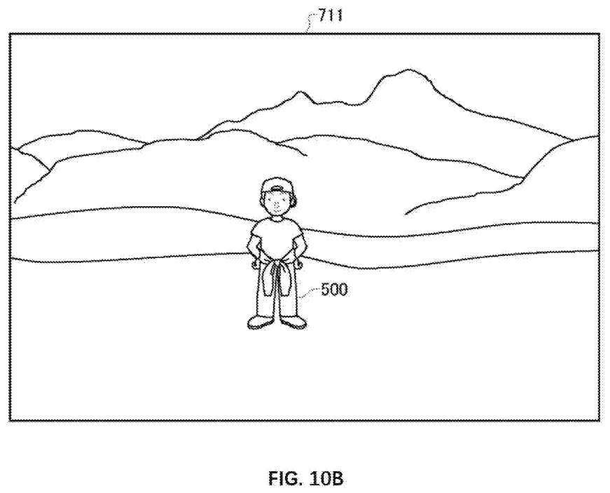

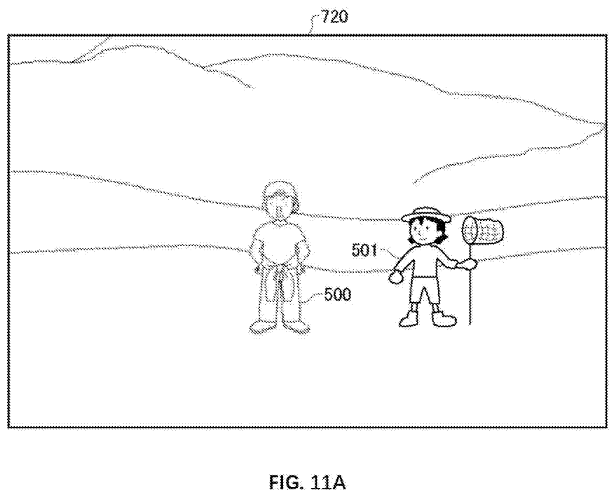

The first photographed object of interest may also be the same as the second photographed object of interest. For example, the photographed object of interest that exists in the first focus position at the first time point may also move to the second focus position at the second time point. For example, the photographing apparatus 100 may shoot, at the first focus distance and the first zoom ratio at the first time point, an image 710 of the photographed object 500 in the focusing state shown in FIG. 10A. The photographing apparatus 100 may shoot, at the second focus distance and the second zoom ratio less than the first zoom ratio at the second time point, an image 711 of the photographed object 500 in the focusing state shown in FIG. 10B. Therefore, a dynamic image shot from the first time point to the second time point may include a representation of maintaining a size of the photographed object 500 moving in a period from the first time point to the second time point on an image plane when the size of the background changes on the image plane.

When the first focus position is different from the second focus position, the determining unit 32 may determine a setting-value for focusing of the photographing apparatus 100, a setting-value for zooming of the photographing apparatus 100, and a moving speed of the UAV 10 at each time point from the first time point to the second time point, so that a size of an object photographed in the first focus position by the photographing apparatus 100 at the first time point on an image plane and a size of an object photographed in a position corresponding to the first focus position by the photographing apparatus 100 at the second time point on an image plane satisfy a predetermined condition.

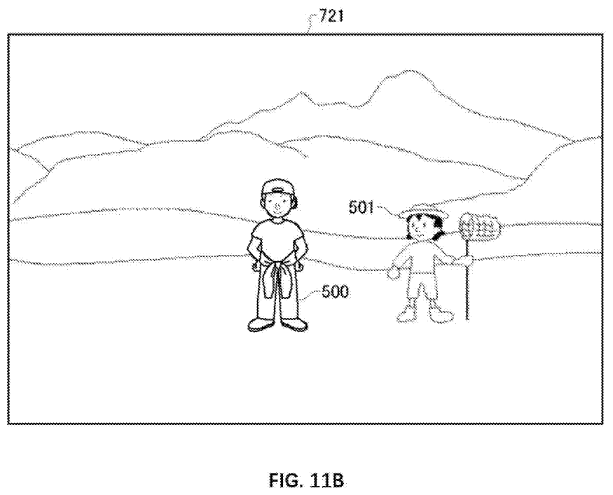

The predetermined condition, in this case, may be a condition that the size of the object photographed in the first focus position by the photographing apparatus 100 at the first time point on the image plane is consistent with the size of the object photographed in the position corresponding to the first focus position by the photographing apparatus 100 at the second time point on the image plane. Under this condition, a dynamic image shot from the first time point to the second time point may include a representation of maintaining a size of the photographed object of interest that exists in the first focus position on an image plane when the size of the background changes on the image plane. The dynamic image may include a representation in which the photographed object of interest in the first focus position enters the focusing state at the first time point and another photographed object of interest that exists in the second focus position enters the focusing state at the second time point. For example, the photographing apparatus 100 may shoot, at the first focus distance and the first zoom ratio at the first time point, an image 720 including the photographed object 500 in the focusing state and a photographed object 501 in the focusing state shown in FIG. 11A. Further, the photographing apparatus 100 may shoot, at the second focus distance and the second zoom ratio less than the first zoom ratio at the second time point, an image 721 including the photographed object 500 in the focusing state and the photographed object 501 not in the focusing state shown in FIG. 11B.

When the first focus position is different from the second focus position, the determining unit 32 may determine a setting-value for focusing of the photographing apparatus 100, a setting-value for zooming of the photographing apparatus 100, and a moving speed of the UAV 10 at each time point from the first time point to the second time point, so that a size of an object photographed in a position corresponding to the second focus position by the photographing apparatus 100 at the first time point on an image plane and a size of an object photographed in the second focus position by the photographing apparatus 100 at the second time point on an image plane satisfy a predetermined condition.

The predetermined condition, in this case, may be a condition that the size of the object photographed in the position corresponding to the second focus position by the photographing apparatus 100 at the first time point on the image plane is consistent with the size of the object photographed in the second focus position by the photographing apparatus 100 at the second time point on the image plane. Under this condition, a dynamic image shot from the first time point to the second time point may give a performance of maintaining the size of the photographed object of interest that exists in the second focus position on the image plane when the size of the background changes on the image plane. The dynamic image may give a performance in which the photographed object of interest that exists in the position corresponding to the second focus position at the first time point is not in the focusing state but the photographed object of interest that exists in the second focus position at the second time point enters the focusing state.

In comparison with a case of zooming to a wide-angle side, it is difficult to obtain a focusing state in a case of zooming to a telephoto side, because in the case of zooming to the telephoto side, when dolly zooming starts, it is difficult to find a photographed object to be focused. Therefore, in some exemplary embodiments, the first focus distance at the first time point may be longer than the second focus distance at the second time point. For example, in some exemplary embodiments, from the first time point to the second time point, the UAV 10 may move in a manner of approaching the photographed object of interest, and the photographing apparatus 100 may perform photographing. Therefore, from the first time point to the second time point, it is easy to maintain the focusing state of the photographed object of interest.

For example, the photographing apparatus 100 may be actually moved relative to the photographed object, and the obtaining unit 31 may obtain the focus distance from the first time point to the second time point. Then the photographing apparatus 100 may be further caused to actually move relative to the photographed object again, and the photographing apparatus 100 is caused to shoot a dynamic image that generates a dolly zoom effect. In this case, when the photographing apparatus 100 moves toward the photographed object, the zoom ratio is changed from the telephoto side to the wide-angle side, and the obtaining unit 31 may obtain the focus distance. Therefore, it is easier for the photographing apparatus 100 to obtain the focus distance for focusing the photographed object from the first time point to the second time point. In addition, when the photographing apparatus 100 performs photographing to obtain a dynamic image with a dolly zoom effect, during moving of the photographing apparatus 100 away from the photographed object, the photographing apparatus 100 may control the focus lens and the zoom lens based on the pre-obtained focus distance, and perform photographing by changing the zoom ratio from the wide-angle side to the telephoto side.

Based on the time T, the first zoom ratio, and the second zoom ratio, the determining unit 32 may determine each control value for optical zooming and electronic zooming as a setting-value for zooming of the photographing apparatus 100 at each time point from the first time point to the second time point. The determining unit 32 may determine each control value for optical zooming and electronic zooming as a setting-value for zooming of the photographing apparatus 100, to switch from optical zooming to electronic zooming. The determining unit 32 may determine each control value for optical zooming and electronic zooming as a setting-value for zooming of the photographing apparatus 100, to switch from electronic zooming to optical zooming.

Based on the time T, the first zoom ratio, and the second zoom ratio, the determining unit 32 may determine a setting-value for focusing of the focus lens 210 and a setting-value for zooming of the zoom lens 211 at each time point from the first time point to the second time point. Based on a predetermined relationship between a location of the focus lens 210 and a location of the zoom lens 211, the determining unit 32 may determine a setting-value for focusing of the focus lens 210 and a setting-value for zooming of the zoom lens 211 at each time point from the first time point to the second time point.

The determining unit 32 may determine a setting-value for focusing and a setting-value for zooming at each time point from the first time point to the second time point, so that a size of an object photographed in the first focus position by the photographing apparatus at the first time point on an image plane and a size of an object photographed in the second focus position by the photographing apparatus at the second time point on an image plane satisfy a predetermined condition. The predetermined condition may be a condition that the size of the object photographed in the first focus position by the photographing apparatus 100 at the first time point on the image plane is consistent with the size of the object photographed in the second focus position by the photographing apparatus 100 at the second time point on the image plane.

When the photographing apparatus 100 causes the zoom ratio to change from the second zoom ratio to a third zoom ratio by performing electronic zooming from the second time point to a third time point, the determining unit 32 may determine a setting-value for focusing of the focus lens 210 at each time point from the second time point to the third time point. Based on the focus distance at the second time point and the speed of the UAV 10, the determining unit 32 may determine a setting-value for focusing of the focus lens 210 at each time point from the second time point to the third time point.

During moving of the photographing apparatus 100 from the first time point to the second time point, based on a predetermined relationship (for example, a zoom tracking curve) between a location of the focus lens 210 and a location of the zoom lens 211, by using the lens control unit 220, the UAV control unit 30 may cause the focus lens 210 and the zoom lens 211 to move, to cause the zoom ratio of the photographing apparatus 100 to change from the first zoom ratio to the second zoom ratio that is n times the first zoom ratio, and to cause the focus distance of the photographing apparatus 100 to change from the first focus distance to the second focus distance that is n times the first focus distance.

Further, during moving of the photographing apparatus 100 from the second time point to the third time point, by performing electronic zooming, the UAV control unit 30 may cause the zoom ratio of the photographing apparatus 100 to change from the second zoom ratio to a third zoom ratio that is m times the first zoom ratio, and by causing the focus lens 210 to move, the UAV control unit 30 may cause the focus distance of the photographing apparatus 100 to change from the second focus distance to a third focus distance that is m times the first focus distance. Herein electronic zooming may be implemented by changing a size cut from an image output by the image sensor 120. During electronic zooming, the photographing apparatus 100 may cause the focus lens 210 to move, to change the focus distance based on a distance from the photographed object, instead of performing optical zooming. Therefore, the photographing apparatus 100 may use electronic zooming to shoot a dynamic image generating a dolly zoom effect.

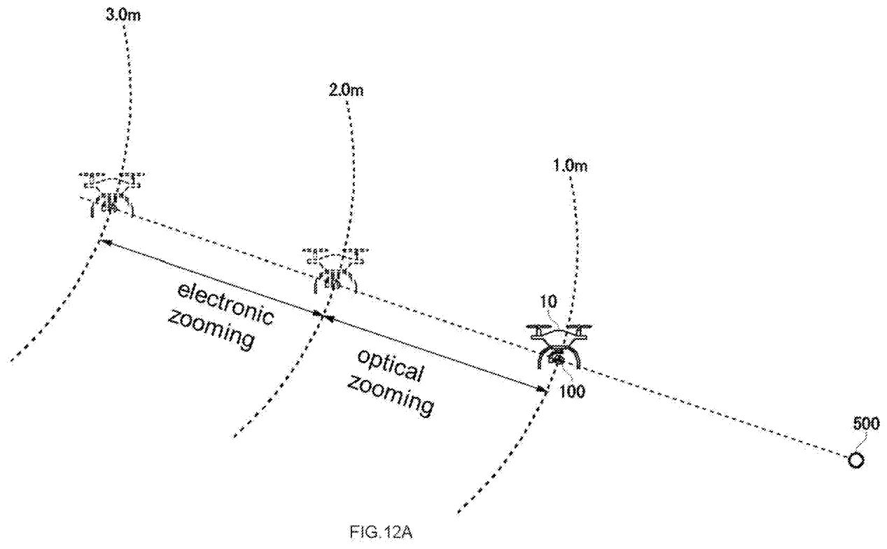

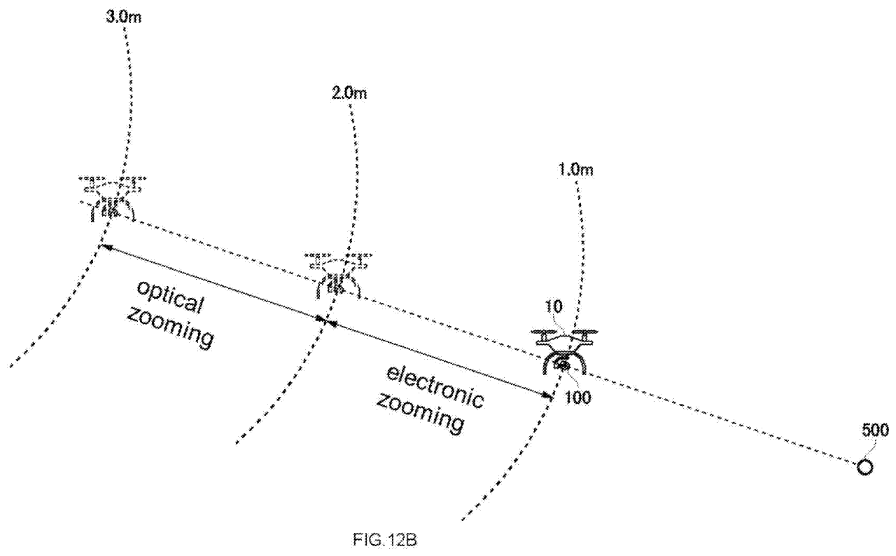

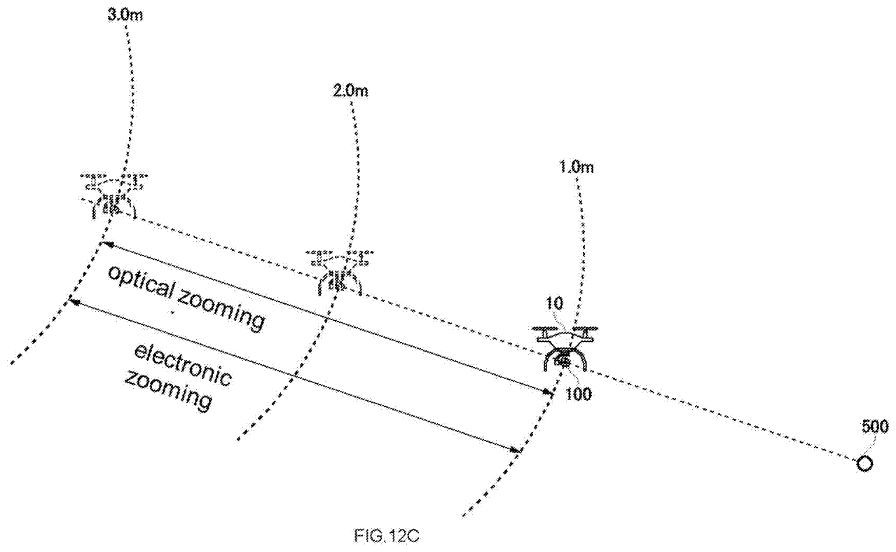

For example, as shown in FIG. 12A, the UAV 10 may fly along the photographing direction of the photographing apparatus 100, so that the distance from the photographed object 500 changes from 1.0 m to 2.0 m. In this period, the photographing apparatus 100 may perform optical zooming by controlling the focus lens 210 and the zoom lens 211, to cause the zoom ratio to change from 1 to 2 and cause the focus distance to change from 1.0 m to 2.0 m. Further, the UAV 10 may fly along the photographing direction of the photographing apparatus 100 to cause the distance from the photographed object to change from 2.0 m to 3.0 m. In this period, the photographing apparatus 100 may perform electronic zooming to cause the zoom ratio to change from 2 to 3, and by controlling the focus lens 210, causes the focus distance to change from 2.0 m to 3.0 m.

In some exemplary embodiments, after causing the photographing apparatus 100 to perform electronic zooming, the UAV control unit 30 may cause the photographing apparatus 100 to perform optical zooming. In this case, during moving of the photographing apparatus 100 from the first time point to the second time point, by performing electronic zooming, the UAV control unit 30 may cause the zoom ratio of the photographing apparatus to change from the first zoom ratio to the second zoom ratio that is n times the first zoom ratio, and cause the focus lens 210 to move by using the lens control unit 220, causing the focus distance of the photographing apparatus 100 to change from the first focus distance to the second focus distance that is n times the first focus distance.

Further, during moving of the photographing apparatus 100 from the second time point to the third time point, based on a predetermined relationship between a location of the focus lens 210 and a location of the zoom lens 211, the UAV control unit 30 may cause the focus lens 210 and the zoom lens 211 to move, to cause the zoom ratio of the photographing apparatus 100 to change from the second zoom ratio to the third zoom ratio that is m times the first zoom ratio, and cause the focus distance of the photographing apparatus 100 to change from the second focus distance to the third focus distance that is m times the first focus distance.

Based on the time T required for causing the zoom ratio of the photographing apparatus 100 to change from the first zoom ratio to the second zoom ratio, the first zoom ratio, the second zoom ratio, the information indicating the first focus distance, and the information indicating the second focus distance, the determining unit 32 may determine a setting-value for focusing of the photographing apparatus 100 at each time point from the first time point to the second time point. Based on time required for causing the zoom ratio of the photographing apparatus 100 to change from the second zoom ratio to the third zoom ratio, the second zoom ratio, the third zoom ratio, the information indicating the second focus distance, and information indicating the third focus distance, the determining unit 32 may determine a setting-value for focusing and a setting-value for zooming at each time point from the second time point to the third time point. Based on first information indicating a relationship between a location of the zoom lens 211 and a location of the focus lens 210 in the second focus distance, and second information indicating a relationship between a location of the zoom lens 211 and a location of the focus lens 210 in the third focus distance, the determining unit 32 may further determine a setting-value for focusing and a setting-value for zooming at each time point from the second time point to the third time point.

For example, as shown in FIG. 12B, the UAV 10 may fly along the photographing direction of the photographing apparatus 100, so that the distance from the photographed object 500 changes from 1.0 m to 2.0 m. In this period, the photographing apparatus 100 may perform electronic zooming, to cause the zoom ratio to change from 1 to 2, and by controlling the focus lens 210, causes the focus distance to change from 1.0 m to 2.0 m. Further, the UAV 10 may fly along the photographing direction of the photographing apparatus 100 to cause the distance from the photographed object to change from 2.0 m to 3.0 m. In this period, the photographing apparatus 100 may perform optical zooming by controlling the focus lens 210 and the zoom lens 211, to cause the zoom ratio to change from 2 to 3, and cause the focus distance to change from 2.0 m to 3.0 m.

The UAV control unit 30 may cause the photographing apparatus 100 to perform optical zooming and electronic zooming simultaneously in at least a part of time periods. During moving of the photographing apparatus 100 from the first time point to the second time point, by performing electronic zooming of the photographing apparatus 100 and causing the focus lens 210 and the zoom lens 211 to move based on a predetermined relationship (e.g., a zoom tracking curve) between a location of the focus lens 210 and a location of the zoom lens 211 by using the lens control unit 220, the UAV control unit 30 may cause the zoom ratio of the photographing apparatus 100 to change from the first zoom ratio to the second zoom ratio that is n times the first zoom ratio, and cause the focus distance of the photographing apparatus 100 to change from the first focus distance to the second focus distance that is n times the first focus distance.

Based on the time T required for causing the zoom ratio of the photographing apparatus 100 to change from the first zoom ratio to the second zoom ratio, the first zoom ratio, the second zoom ratio, the information indicating the first focus distance, and the information indicating the second focus distance, the determining unit 32 may determine a setting-value for focusing and a setting-value for zooming at each time point from the first time point to the second time point. Based on first information indicating a relationship between a location of the zoom lens 211 and a location of the focus lens 210 in the first focus distance, and second information indicating a relationship between a location of the zoom lens 211 and a location of the focus lens 210 in the second focus distance, the determining unit 32 may further determine a setting-value for focusing and a setting-value for zooming at each time point from the first time point to the second time point.

For example, as shown in FIG. 12C, the UAV 10 may fly along the photographing direction of the photographing apparatus 100, so that the distance from the photographed object 500 changes from 1.0 m to 3.0 m. In this period, the photographing apparatus 100 may perform electronic zooming and optical zooming to cause the zoom ratio to change from 1 to 3, and cause the focus distance to change from 1.0 m to 3.0 m.

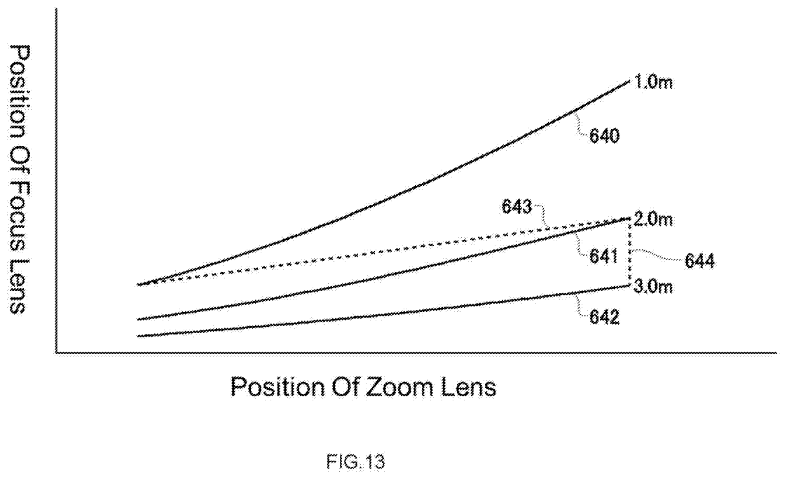

FIG. 13 is a diagram showing a relationship between a location of the focus lens 210 and a location of the zoom lens 211 according to some exemplary embodiments. FIG. 13 shows a zoom tracking curve 640 when the focus distance is 1.0 m, a zoom tracking curve 641 when the focus distance is 2.0 m, and a motion tracking curve 643 when the focus distance is 3.0 m.

As shown in FIG. 12A, when causing the distance from the UAV 10 to the photographed object 500 to change from 1.0 m to 2.0 and the zoom ratio to change from 1 to 2, the determining unit 32 may, for example, based on the zoom tracking curve 640 when the focus distance is 1.0 m and the zoom tracking curve 641 when the focus distance is 2.0 m, derive the motion tracking curve 643 indicating a relationship between the location of the zoom lens 211 and the location of the focus lens 210 when the zoom ratio is caused to change from 1 to 2. By performing electronic zooming, the determining unit 32 may further determine a setting-value for focusing of the focus lens 210 when the zoom ratio is caused to change from 2 to 3. Because the zoom lens 211 does not move, the determining unit 32 may determine a setting-value for focusing of the focus lens 210, so that the location of the focus lens 210 changes according to a straight line shown by a symbol 644.

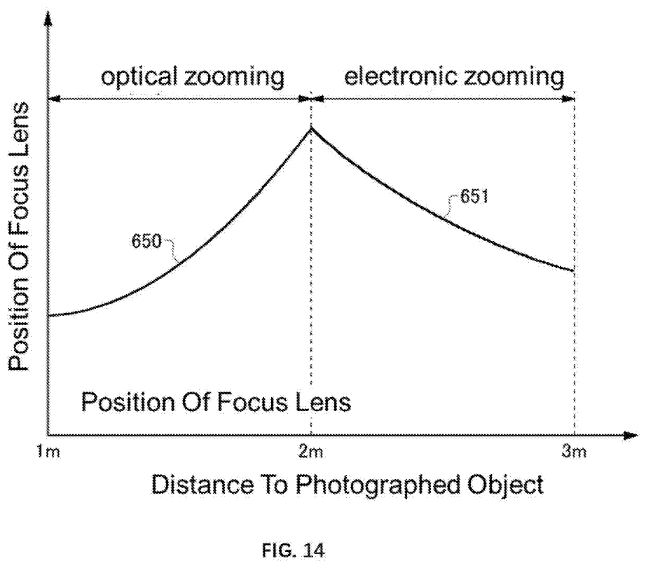

FIG. 14 shows a case of a location change of the focus lens 210 when the photographing apparatus 100 performs electronic zooming after performing optical zooming. As shown in FIG. 14, when the focus distance of the photographing apparatus 100 changes from 1.0 m to 2.0 m, by using the lens control unit 220, the UAV control unit 30 may cause the focus lens 210 to move along a curve 650 determined based on the zoom tracking curve. Further, when the focus distance of the photographing apparatus 100 changes from 2.0 m to 3.0 m, by using the lens control unit 220, the UAV control unit 30 may cause the focus lens 210 to move along a curve 651 determined based on a moving speed of the photographing apparatus 100 (e.g., of UAV 10).

Herein a maximum speed at which the UAV 10 can move may be limited. Therefore, based on a length of the time T, or a moving distance of the UAV 10 from the first time point to the second time point, the UAV 10 may be unable to move the moving distance within the time T.

A maximum speed at which the zoom lens 211 can move may be limited. Based on a length of the time T, the zoom ratio of the zoom lens 211 may be unable to change from the first zoom ratio to the second zoom ratio within the time T.

A minimum speed at which the zoom lens 211 can move may also be limited. The zoom ratio of the zoom lens 211 may be unable to change from the first zoom ratio to the second zoom ratio within the time T. For example, to cause the zoom lens 211 to move within the time T, a speed of the zoom lens 211 may be very low.

When an obstacle exists on a route on which the UAV 10 moves from the first time point to the second time point, the UAV 10 may be unable to move on the route.

Therefore, based on the time T, the first zoom ratio, the second zoom ratio, the first focus distance, and the second focus distance, the photographing apparatus 100 may be unable to shoot a dynamic image with a dolly zoom effect.

Therefore, based on the time T, the first zoom ratio, the second zoom ratio, the first focus distance, and the second focus distance, the judging unit 33 may determine whether the photographing apparatus 100 can shoot a dynamic image with a dolly zoom effect.

Based on at least one of the time T, the first zoom ratio, the second zoom ratio, and the minimum speed and the maximum speed of the zoom lens 211, the judging unit 33 may determine whether the zoom ratio of the photographing apparatus 100 can be changed from the first zoom ratio to the second zoom ratio within the time T. When the judging unit 33 determines that the zoom ratio of the photographing apparatus 100 can be changed from the first zoom ratio to the second zoom ratio within the time T, the determining unit 32 may determine a setting-value for focusing of the photographing apparatus 100, a setting-value for zooming of the photographing apparatus 100, and a moving speed of the UAV 10 at each time point from the first time point to the second time point.

Based on the time T, a difference between the first focus distance and the second focus distance, and a maximum speed of the UAV 10, the judging unit 33 may determine whether the UAV 10 can move the difference between the first focus distance and the second focus distance within the time T. When the judging unit 33 determines that the UAV 10 can move the difference between the first focus distance and the second focus distance within the time T, the determining unit 32 may determine a setting-value for focusing of the photographing apparatus 100, a setting-value for zooming of the photographing apparatus 100, and a moving speed of the UAV 10 at each time point from the first time point to the second time point.

The judging unit 33 may determine whether an obstacle exists on a path enabling the UAV 10 to move the difference between the first focus distance and the second focus distance. When the judging unit 33 determines that no obstacle exists on the path, the determining unit 32 may determine a setting-value for focusing of the photographing apparatus 100, a setting-value for zooming of the photographing apparatus, and a moving speed of the UAV 10 at each time point from the first time point to the second time point. Based on a three-dimensional map stored in the memory 37 and location information of the UAV 10, the judging unit 33 may determine whether an obstacle exists on the path enabling the UAV 10 to move the difference between the first focus distance and the second focus distance. Based on an image shot by the photographing apparatus 100 or a photographing apparatus 60 used as a stereoscopic camera, the judging unit 33 may determine whether an obstacle exists on the path enabling the UAV 10 to move the difference between the first focus distance and the second focus distance.

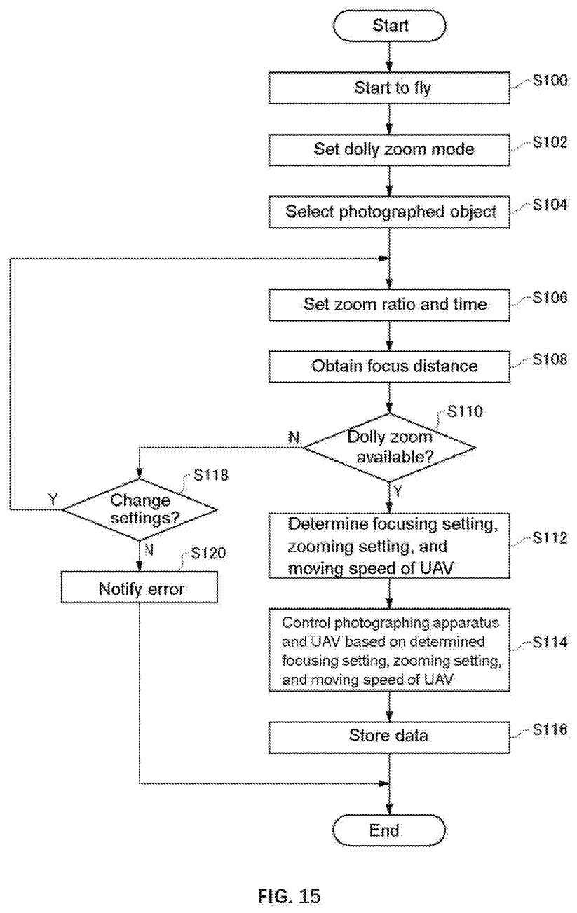

FIG. 15 is a flowchart showing a photographing process of the photographing apparatus 100 carried on the UAV 10 according to some exemplary embodiments.

The UAV 10 starts to fly (S100). The UAV control unit 30 receives a mode setting instruction from the remote operation apparatus 300, and sets a photographing mode of the photographing apparatus 100 to a dolly zoom mode (S102). The UAV control unit 30 may accept selection of a photographed object of interest by using real-time framing of the photographing apparatus 100 displayed on a display unit of the remote operation apparatus 300 (S104). The UAV control unit 30 may have an accepting unit, which accepts a photographed object of interest from an image shot by the photographing apparatus 100. The accepting unit may also accept selection of a plurality of photographed objects of interest from the image. The receiving unit may accept selection of a photographed object of interest at a start time point of dolly zooming, and a photographed object of interest at an end time point of dolly zooming. The receiving unit may accept selection of a photographed object of interest at each time point from a start time point of dolly zooming to an end time point of dolly zooming.

By using the remote operation apparatus 300, the UAV control unit 30 accepts a first zoom ratio at a first time point (e.g., start time point of dolly zooming), a second zoom ratio at a second time point (e.g., end time point of dolly zooming), and time T used as photographing time with dolly zooming, and performs setting (S106). The UAV control unit 30 may set the first zoom ratio, the second zoom ratio, and the time T based on setting information prestored in the memory 37 or the like. The UAV control unit 30 may accept only a change from a telephoto side to a wide-angle side or a change from a wide-angle side to a telephoto side. Based on the change from the telephoto side to the wide-angle side or the change from the wide-angle side to the telephoto side, the UAV control unit 30 may set a predetermined zoom ratio on the telephoto side and a predetermined zoom ratio on the wide-angle side as zoom ratios at the first time point and the second time point. The UAV control unit 30 may accept the time T from a plurality of predetermined candidate time periods. For example, the UAV control unit 30 may set the time T by accepting an expected time mode from a long time mode, a medium time mode, and a short time mode.

The obtaining unit 31 may obtain information indicating a focus distance, where the focus distance is a distance from the photographing apparatus 100 to the photographed object of interest (108). The obtaining unit 31 may obtain information indicating a first focus distance from the photographed object of interest at the first time point. The obtaining unit 31 may derive a second focus distance based on the first zoom ratio, the second zoom ratio, and the first focus distance. The obtaining unit 31 may derive a second focus distance by multiplying the first focus distance by a ratio of the first zoom ratio to the second zoom ratio.

The judging unit 33 may determine, based on the time T, the first zoom ratio, the second zoom ratio, the first focus distance, and the second focus distance, whether the photographing apparatus 100 can shoot a dynamic image with a dolly zoom effect (S110). Based on the time T, the first zoom ratio, the second zoom ratio, the first focus distance, and the second focus distance, the judging unit 33 may determine whether the photographing apparatus 100 can shoot a dynamic image with a dolly zoom effect.

Based on at least one of the time T, the first zoom ratio, the second zoom ratio, and the minimum speed and the maximum speed of the zoom lens 211, the judging unit 33 may determine whether the zoom ratio of the photographing apparatus 100 can be changed from the first zoom ratio to the second zoom ratio within the time T. Based on the time T, a difference between the first focus distance and the second focus distance, and a maximum speed of the UAV 10, the judging unit 33 may determine whether the UAV 10 can move the difference between the first focus distance and the second focus distance within the time T. The judging unit 33 may determine whether an obstacle exists on a path enabling the UAV 10 to move the difference between the first focus distance and the second focus distance.

When the judging unit 33 determines that the photographing apparatus 100 cannot shoot a dynamic image with a dolly zoom effect, the judging unit 33 may notify a setting change request to a user by using the remote operation apparatus 300. The judging unit 33 may notify the time T capable of photographing with dolly zooming, the first focus distance, or the zoom ratio to the user. When the judging unit 33 accepts a setting change request from the user (S118), the UAV control unit 30 may reset the zoom ratio and time based on the setting change request (S106). When accepting a motion instruction from the user for the UAV 10, the UAV control unit 30 may cause the UAV 10 to move relative to the photographed object, to adjust a distance from the photographed object.

When there is no setting change request, the judging unit 33 may notify the user, by using the remote operation apparatus 300, an error indicating that photographing with dolly zooming cannot be performed (S120).

When photographing with dolly zooming can be performed, the determining unit 32 may determine a setting-value for focusing of the photographing apparatus 100, a setting-value for zooming of the photographing apparatus 100, and a moving speed of the UAV 10 at each time point from the first time point to the second time point (S112). Based on a motion tracking curve of the first focus distance at the first time point and a motion tracking curve of the second focus distance at the second time point, the determining unit 32 may determine a setting-value for focusing of the photographing apparatus 100, a setting-value for zooming of the photographing apparatus 100, and a moving speed of the UAV 10 at each time point from the first time point to the second time point.

The UAV control unit 30 may control a location of the zoom lens 211, a location of the focus lens 210, and motion of the UAV 10 based on the setting-value for focusing of the photographing apparatus 100, the setting-value for zooming of the photographing apparatus 100, and the moving speed of the UAV 10 at each time point from the first time point to the second time point (S114). Therefore, the photographing apparatus 100 may change the zoom ratio and the focus distance in a period of changing the distance from the photographed object from the first time point to the second time point. For example, the photographing apparatus 100 may perform photographing in a manner of maintaining a size of a photographed object of interest on an image plane while moving from the first time point to the second time point. Therefore, the photographing apparatus 100 can shoot a dynamic image that maintains a size of the photographed object of interest on the image plane and a focusing state while changing a size of a background and the number of blurs.

It should be noted that in the foregoing examples, examples of moving of the UAV 10 along the photographing direction of the photographing apparatus 100 has been described. However, the UAV 10 may move in a manner of crossing a photographed object, and the universal joint 50 may control a posture of the photographing apparatus 100, so that the photographing direction of the photographing apparatus 100 faces a photographed object side. In some exemplary embodiments, the UAV 10 may control an orientation of the UAV 10 when moving in a manner of crossing a photographed object, so that the photographing direction of the photographing apparatus 100 faces a photographed object side. In some exemplary embodiments, the UAV 10 may control an orientation of the UAV 10 when moving in a manner of crossing a photographed object, and control a posture of the photographing apparatus 100 by using the universal joint 50, so that the photographing direction of the photographing apparatus 100 faces a photographed object side. When ascending or descending, the UAV 10 may control at least one of a posture of the photographing apparatus 100 and an orientation of the UAV 10 that are adjusted by the universal joint 50, so that the photographing direction of the photographing apparatus 100 faces a photographed object side. It may be understood from FIG. 4 that a motion tracking range is, for example, between the zoom tracking curve 601 and the zoom tracking curve 602. Therefore, it may be specified that the UAV 10 can move in the motion tracking range. The motion tracking range may be set to a three-dimensional space area. For example, by using a motion tracking mode, a motion area of the UAV 10 may be controlled. The motion area of the UAV 10 may be set to a hollow sphere in a three-dimensional space or a hollow hemisphere in a three-dimensional space that uses the photographed object as a center. The motion area of the UAV 10 may be set based on at least one of the time T, the first zoom ratio, the second zoom ratio, a minimum speed of the zoom lens 211, a maximum speed of the zoom lens 211, and a maximum speed of the UAV 10.

The photographing apparatus 100 may also adjust an aperture from the first time point to the second time point. The determining unit 32 may determine an aperture value of the photographing apparatus 100 at each time point from the first time point to the second time point based on the time T, the first zoom ratio, the second zoom ratio, the first focus distance, and the second focus distance. The determining unit 32 may determine a control value of the aperture of the photographing apparatus 100 at each time point from the first time point to the second time point, so that a blur degree of the background from the first time point to the second time point does not change. The determining unit 32 may determine a first control value for the aperture at the first zoom ratio (e.g., on telephoto side) at the first time point, and determine a second control value less than the first control value for the aperture at the second zoom ratio (e.g., on wide-angle side) less than the first zoom ratio at the second time point.

The photographing apparatus 100 may also adjust an F value from the first time point to the second time point. The determining unit 32 may determine an F value of the photographing apparatus 100 at each time point from the first time point to the second time point based on the time T, the first zoom ratio, the second zoom ratio, the first focus distance, and the second focus distance. The determining unit 32 may determine an F value of the photographing apparatus 100 at each time point from the first time point to the second time point, so that luminance (e.g., a luminance value) of the photographed object of interest from the first time point to the second time point does not change in an image. The determining unit 32 may determine the F value as the first control value at the first zoom ratio (e.g., on telephoto side) at the first time point, and determine the F value as the second control value greater than the first control value at the second zoom ratio (e.g., wide-angle side) less than the first zoom ratio at the second time point.

The photographing apparatus 100 may adjust ISO sensitivity (e.g., gain) from the first time point to the second time point. The determining unit 32 may determine ISO sensitivity of the photographing apparatus 100 at each time point from the first time point to the second time point based on the time T, the first zoom ratio, the second zoom ratio, the first focus distance, and the second focus distance. The determining unit 32 may determine ISO sensitivity and a shutter speed of the photographing apparatus 100 at each time point from the first time point to the second time point based on the time T, the first zoom ratio, the second zoom ratio, the first focus distance, and the second focus distance. The determining unit 32 may determine ISO sensitivity and the shutter speed of the photographing apparatus 100 at each time point from the first time point to the second time point based on the time T, the first zoom ratio, the second zoom ratio, the first focus distance, and the second focus distance, to keep exposure unchanged.

To reduce image flickers, the photographing apparatus 100 may disable an automatic exposure function and an automatic white balance function when performing an action in a dolly zoom mode.

The UAV 10 may move in a manner that causes the selected photographed object of interest to be included in a central area of the image shot by the photographing apparatus 100. In some exemplary embodiments, the UAV 10 may move in a manner that causes any point other than the photographed object of interest in the image shot by the photographing apparatus 100 at the first time point to be included in a central area of the image. When dolly zooming is performed, electronic zooming can be performed after optical zooming. When dolly zooming is performed, optical zooming can be performed after electronic zooming. In this way, a moving distance of the UAV 10 can be extended. Therefore, the dolly zoom effect can be better achieved.

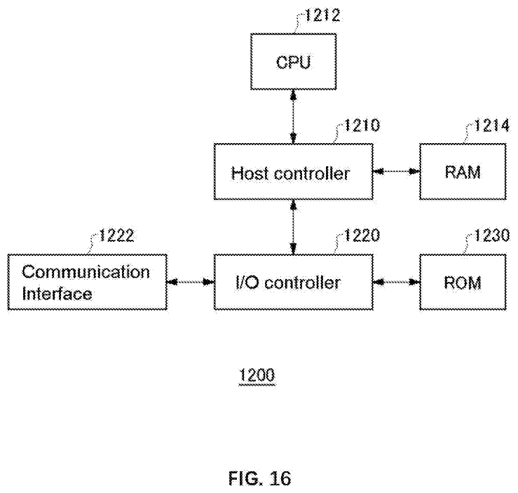

FIG. 16 shows a computer 1200 that may reflect a plurality of manners of the present disclosure completely or partially according to some exemplary embodiments. A program installed in the computer 1200 can enable the computer 1200 to act as an operation associated with an apparatus in the implementation of the present disclosure or one or more “units” of the apparatus to implement functions. In some exemplary embodiments, the program can enable the computer 1200 to perform the operation or the one or more “units”. The program can enable the computer 1200 to perform the process in the implementation of the present disclosure or a stage of the process. The program may be executed by a CPU 1212, to enable the computer 1200 to perform specified operations associated with some or all blocks in the flowchart and block diagram in the specification.

In some exemplary embodiments, the computer may include the CPU 1212 and a RAM 1214, which may be interconnected by using a host controller 1210. The computer 1200 may further include a communication interface 1222 and an input/output unit, which may be connected to the host controller 1210 by using an input/output controller 1220. The computer 1200 may further include a ROM 1230. The CPU 1212 may operate according to programs stored in the ROM 1230 and the RAM 1214, thereby controlling each unit.

The communication interface 1222 may communicate with other electronic apparatuses by using a network. A hard disk drive may store programs and data that are used by the CPU 1212 in the computer 1200. The ROM 1230 may store a boot program and so on executed by the computer 1200 during running, and/or programs of hardware depending on the computer 1200. The programs may be provided by a computer-readable recording medium such as a CD-ROM, a USB memory, or an IC card, or provided by the network. The programs may be installed in the RAM 1214 or the ROM 1230 also used as an example of the computer-readable recording medium, and may be executed by the CPU 1212. Information recorded in the programs may be read by the computer 1200, and may cause coordination between the programs and the foregoing various types of hardware resources. An information operation or processing may be implemented based on use of the computer 1200 to constitute an apparatus or a method.

For example, when the computer 1200 communicates with an external apparatus, the CPU 1212 may execute a communication program loaded in the RAM 1214, and command, based on processing described in the communication program, the communication interface 1222 to perform communication processing. Under the control of the CPU 1212, the communication interface 1222 may read sent data in a send buffer provided by a recording medium such as the RAM 1214 or a USB memory, and send the read sent data to the network, or write received data received from the network into a receive buffer provided by the recording medium, or the like.

In addition, the CPU 1212 may enable the RAM 1214 to read all or a required part of files or databases stored by an external recording medium such as a USB memory and perform various types of processing on data in the RAM 1214. Then the CPU 1212 may write processed data back to the external recording medium.

Various types of information such as various types of programs, data, tables, and databases may be stored in the recording medium, and information processing may be conducted. For data read from the RAM 1214, the CPU 1212 may perform various types of processing such as various types of operations specified by an instruction sequence of the program, information processing, condition judgment, conditional transfer, unconditional transfer, and information retrieval/replacement, which may be described throughout the present disclosure, and write results back to the RAM 1214. In addition, the CPU 1212 may retrieve information in a file or database or the like in the recording medium. For example, when the recording medium stores a plurality of items having attribute values of first attributes respectively associated with attribute values of second attributes, the CPU 1212 may retrieve, from the plurality of items, an item matching a condition of an attribute value of a specified first attribute, and read an attribute value of a second attribute stored in the item, to obtain the attribute value of the second attribute associated with the first attribute satisfying the predetermined condition.

The foregoing program or software module may be stored in the computer 1200 or in a computer-readable storage medium near the computer 1200. In addition, a recording medium such as a hard disk or a RAM provided in a server system connected to a private communications network or the Internet may be used as a computer-readable storage medium, so that the program can be provided to the computer 1200 by using the network.

It should be noted that an execution sequence of various types of processing such as the action, sequence, step, and stage in the apparatus, system, program, and method in the claims, specification, and accompanying drawings may be any sequence that can be implemented as long as a previous processing output is not used in subsequent processing and wordings such as “before” and “beforehand” are not particularly indicated explicitly. For the action procedure in the claims, specification, and accompanying drawings, “first”, “then”, and the like are used for ease of description, but do not mean that the implementation must be based on such a sequence.

Although the present disclosure is described by using the implementations above, the technical scope of the present disclosure is not limited to the scope described in the implementations. For a person of ordinary skill in the art, various variations or improvements may be made to the implementations. Obviously, from the descriptions of the claims, any manner of such variations or improvements may be included in the technical scope of the present disclosure.

What is claimed is:

1. A control apparatus, comprising:
a control unit to control a lens system of a photographing apparatus to, when a distance between an object-side focus of the lens system and a photographed object is changed from a first distance a to a second distance n×a due to moving of the photographing apparatus,
change a focal length of the lens system from a first focal length f to a second focal length n×f, and
change a distance between an image-side focus of the lens system and an image plane from a third distance b to a fourth distance n×b, wherein n is a real number.

2. The control apparatus according to claim 1, wherein the lens system includes a zoom lens system and a focus lens system,
wherein the control unit further:
change the focal length of the lens system to the second focal length n×f by controlling the zoom lens system, and
change the distance between the image-side focus of the lens system and the image plane to the fourth distance n×b by controlling the focus lens system.

3. The control apparatus according to claim 2, wherein the control unit further determines a setting-value for focusing of the focus lens system to change the distance between the image-side focus of the lens system and the image plane to the fourth distance n×b based on setting information,
wherein the setting information represents the setting-value for focusing in a manner associated with:
information corresponding to the focal length of the lens system, and
information corresponding to the distance from the object-side focus of the lens system to the photographed object.

4. The control apparatus according to claim 3, wherein the control unit further controls the focus lens system when the lens system changes from a first zoom ratio corresponding to the first focal length f to a second zoom ratio corresponding to the second focal length n×f, so that a relationship of n, r₁, r₂, S₁, and S₂ satisfies a predetermined condition, wherein n=Z₁/Z₂,
Z₁ is the first zoom ratio,
Z₂ is the second zoom ratio,
S₁ is a setting-value for focusing of the focus lens system at the first zoom ratio,
S₂ is a setting-value for focusing of the focus lens system at the second zoom ratio,
r₁ is an amount of movement of the focus lens system that causes the focus lens system to move from an infinitely far side to a nearest side at the first zoom ratio determined based on the setting information, and
r₂ is an amount of movement of the focus lens system that causes the focus lens system to move from an infinitely far side to a nearest side at the second zoom ratio determined based on the setting information.

5. The control apparatus according to claim 4, wherein the control unit further controls the focus lens system to satisfy S₂=(1/n)×(r₂/r₁)×S₁.

6. The control apparatus according to claim 2, further comprising: a determining unit to determine
a setting-value for focusing of the photographing apparatus for changing the first focal length f of the lens system to the second focal length n×f, and
a setting-value for zooming of the photographing apparatus for changing the third distance b from the image-side focus of the lens system to the image plane to the fourth distance n×b,
based on:
a time required for causing a zoom ratio of the photographing apparatus to change from a first zoom ratio corresponding to the first focal length f to a second zoom ratio corresponding to the second focal length n×f,
the first zoom ratio,
the second zoom ratio,
information indicating the first distance a, and
information indicating the second distance n×a.

7. The control apparatus according to claim 6, wherein the determining unit further determines the setting-value for focusing and the setting-value for zooming based on:
first information indicating a relationship between a location of the zoom lens system and a location of the focus lens system under the first distance a, and
second information indicating a relationship between a location of the zoom lens system and a location of the focus lens system under the second distance n×a.

8. The control apparatus according to claim 7, wherein
the first distance a corresponds to a distance from the photographing apparatus to a first focus position at which focusing is to be performed at a first time point,
the second distance n×a corresponds to a distance from the photographing apparatus to a second focus position at which focusing is to be performed at a second time point, and
the determining unit further determines the setting-value for focusing and the setting-value for zooming, so that a size of an object photographed in the first focus position by the photographing apparatus at the first time point on the image plane and a size of an object photographed in the second focus position by the photographing apparatus at the second time point on the image plane satisfy a predetermined condition.

9. The control apparatus according to claim 8, wherein the predetermined condition is a condition that the size of the object photographed in the first focus position by the photographing apparatus at the first time point on the image plane is consistent with the size of the object photographed in the second focus position by the photographing apparatus at the second time point on the image plane.

10. A mobile body, comprising:
a photographing apparatus, and
a control apparatus including a control unit to control a lens system of the photographing apparatus to, when a distance between an object-side focus of the lens system and a photographed object is changed from a first distance a to a second distance n×a due to moving of the photographing apparatus,
change a focal length of the lens system from a first focal length f to a second focal length n×f, and
change a distance between an image-side focus of the lens system and an image plane from a third distance b to a fourth distance n×b, wherein n is a real number.

11. The mobile body according to claim 10, wherein the lens system includes a zoom lens system and a focus lens system,
wherein the control unit further:
changes the focal length of the lens system to the second focal length n×f by controlling the zoom lens system, and
changes the distance between the image-side focus of the lens system and the image plane to the fourth distance n×b by controlling the focus lens system.

12. The control apparatus according to claim 11, wherein the control unit further determines a setting-value for focusing of the focus lens system to change the distance between the image-side focus of the lens system and the image plane to the fourth distance n×b based on setting information,
wherein the setting information represents the setting-value for focusing in a manner associated with:
information corresponding to the focal length of the lens system, and
information corresponding to the distance from the object-side focus of the lens system to the photographed object.

13. The control apparatus according to claim 12, wherein the control unit further controls the focus lens system when a zoom ratio of the lens system changes from a first zoom ratio corresponding to the first focal length f to a second zoom ratio corresponding to the second focal length n×f, so that a relationship of n, r₁, r₂, S₁, and S₂ satisfies a predetermined condition, wherein n=Z₁/Z₂,
Z₁ is the first zoom ratio,
Z₂ is the second zoom ratio,
S₁ is a setting-value for focusing of the focus lens system at the first zoom ratio,
S₂ is a setting-value for focusing of the focus lens system at the second zoom ratio,
r₁ is an amount of movement of the focus lens system that causes the focus lens system to move from an infinitely far side to a nearest side at the first zoom ratio determined based on the setting information, and
r₂ is an amount of movement of the focus lens system that causes the focus lens system to move from an infinitely far side to a nearest side at the second zoom ratio determined based on the setting information.

14. The mobile body according to claim 13, wherein the control unit further controls the focus lens system to satisfy S₂=(1/n)×(r₂/r₁)×S₁.

15. The mobile body according to claim 11, wherein the control apparatus further includes a determining unit to determine
a setting-value for focusing of the photographing apparatus for changing the first focal length f of the lens system to the second focal length n×f, and
a setting-value for zooming of the photographing apparatus for changing the third distance b from the image-side focus of the lens system to the image plane to the fourth distance n×b,
based on
a time required for causing a zoom ratio of the photographing apparatus to change from a first zoom ratio corresponding to the first focal length f to a second zoom ratio corresponding to the second focal length n×f,
the first zoom ratio,
the second zoom ratio,
information indicating the first distance a, and
information indicating the second distance n×a.

16. The mobile body according to claim 15, wherein the determining unit further determines the setting-value for focusing and the setting-value for zooming based on
first information indicating a relationship between a location of the zoom lens system and a location of the focus lens system under the first distance a, and
second information indicating a relationship between a location of the zoom lens system and a location of the focus lens system under the second distance n×a.

17. The mobile body according to claim 16, wherein
the first distance a corresponds to a distance from the photographing apparatus to a first focus position at which focusing is to be performed at a first time point,
the second distance n×a corresponds to a distance from the photographing apparatus to a second focus position at which focusing is to be performed at a second time point, and
the determining unit further determines the setting-value for focusing and the setting-value for zooming, so that a size of an object photographed in the first focus position by the photographing apparatus at the first time point on the image plane and a size of an object photographed in the second focus position by the photographing apparatus at the second time point on the image plane satisfy a predetermined condition.

18. The mobile body according to claim 17, wherein the predetermined condition is a condition that the size of the object photographed in the first focus position by the photographing apparatus at the first time point on the image plane is consistent with the size of the object photographed in the second focus position by the photographing apparatus at the second time point on the image plane.

19. The mobile body according to claim 10, wherein the control unit causes the mobile body to move at a predetermined speed, so that the distance between the object-side focus of the lens system and the photographed object is changed from the first distance a to the second distance n×a.

20. A control method for controlling a lens system of a photographing apparatus, comprising: when a distance between an object-side focus of the lens system and a photographed object is changed from a to n×a due to moving of the photographing apparatus,
changing a focal length of the lens system from f to n×f, and
changing a distance between an image-side focus of the lens system and an image plane from b to n×b, wherein n is a real number.
